(19) United States
(12) Patent Application Publication
(10) Pub. No.: US 2026/0370335 A1
(43) Pub. Date: Nov. 19, 2026

(54) OPTICAL RELAY APPARATUS, OPTICAL TRANSMISSION SYSTEM, AND OPTICAL RELAY METHOD

(71) Applicant: NEC Corporation, Tokyo (JP)

(72) Inventor: Tatsunori OMIYA, Tokyo (JP)

(73) Assignee: NEC Corporation, Tokyo (JP)

(21) Appl. No.: 19/154,399

(22) PCT Filed: Mar. 24, 2023
(86) PCT No.: PCT/JP2023/011868

§ 371 Date: Aug. 7, 2025

(51) Int. Cl. H04B 10/294; H04B 10/50; H04B 10/61

(52) U.S. Cl. CPC H04B 10/294; H04B 10/505; H04B 10/506; H04B 10/61

(57) ABSTRACT

An optical relay device (2) comprises: a coherent reception front end unit (110) that coherently detects an input optical signal to be inputted on the basis of locally emitted light; a coherent transmission front end unit (120) that coherently modulates the coherently detected signal on the basis of transmission light, and outputs a coherently modulated output optical signal; a light source (21) that outputs first light having a first wavelength; a light source (22) that outputs second light having a second wavelength; and a selection unit (130) that selects one of the first light and the second light, and outputs the selected light as locally emitted light or transmission light.

### TECHNICAL FIELD

The present disclosure relates to an optical relay apparatus, an optical transmission system, and an optical relay method.

### BACKGROUND ART

In recent years, utilization of not only wireless communication but also optical communication for various communication services is expected toward a post-5G era. Among them, studies have been carried out for enhancement of Reconfigurable Optical Add/Drop Multiplexer (ROADM) networks, and in particular, attention has been paid to a wavelength conversion technique required at a time of route change. In a Wavelength Division Multiplexing (WDM) network that is becoming complex, a shortest path cannot be established at an End-to-End with a single wavelength due to a wavelength conflict with other signals, and thus it is necessary to establish a path while performing wavelength conversion into an empty wavelength slot.

As a related art, for example, PTL 1 discloses a wavelength converter for converting a wavelength of an optical signal by a reception end and a transmission end using a coherent method.

### CITATION LIST

### Patent Literature

PTL 1: JP 2017-511036 A

### SUMMARY OF INVENTION

### Technical Problem

According to PTL 1, in a wavelength converter, a reception end including a coherent detection front end module converts a received optical signal into an analog electric signal, and a transmission end including an optical modulation module converts the analog electric signal into a transmitted optical signal. However, in PTL 1, upon switching the wavelength to be converted (the wavelength before conversion or the wavelength after conversion by the wavelength converter), for example, the wavelength switching time or the like of a wavelength variable light source for outputting a local oscillation light source or a transmission light source is not taken into consideration, and thus there is a problem that it takes time to switch the wavelength to be converted.

In view of such a problem, an object of the present disclosure is to provide an optical relay apparatus, an optical transmission system, and an optical relay method capable of suppressing a time required for switching a wavelength to be converted.

### Solution to Problem

An optical relay apparatus according to the present disclosure includes a coherent optical receiver front-end means for coherently detecting an input optical signal to be input based on a local oscillation light, a coherent optical transmitter front-end means for coherently modulating the coherently detected signal based on a transmission light and outputting the coherently modulated output optical signal, a first light source for outputting first light having a first wavelength, a second light source for outputting second light having a second wavelength, and a selection means for selecting either one of the first light and the second light and outputting the selected light as the local oscillation light or the transmission light.

An optical transmission system according to the present disclosure includes a plurality of optical relay apparatuses, in which each of the plurality of optical relay apparatuses includes a coherent optical receiver front-end means for coherently detecting an input optical signal input from the optical relay apparatus of a preceding stage based on a local oscillation light, a coherent optical transmitter front-end means for coherently modulating the coherently detected signal based on a transmission light and outputting the coherently modulated output optical signal to the optical relay apparatus of a subsequent stage, a first light source for outputting first light having a first wavelength, a second light source for outputting second light having a second wavelength, and a selection means for selecting either one of the first light and the second light and outputting the selected light as the local oscillation light or the transmission light.

An optical relay method according to the present disclosure includes coherently detecting an input optical signal to be input based on a local oscillation light, coherently modulating the coherently detected signal based on a transmission light and outputting the coherently modulated output optical signal, and selecting either one of first light having a first wavelength output from a first light source and second light having a second wavelength output from a second light source, and outputting the selected light as the local oscillation light or the transmission light.

### Advantageous Effects of Invention

According to the present disclosure, an optical relay apparatus, an optical transmission system, and an optical relay method capable of suppressing a time required for switching a wavelength to be converted can be provided.

### BRIEF DESCRIPTION OF DRAWINGS

FIG. 1 is a configuration diagram illustrating a configuration example of an optical transmission system according to an example embodiment.

FIG. 2 is a configuration diagram illustrating a configuration example of a related optical relay apparatus.

FIG. 3 is a configuration diagram illustrating another configuration example of the related optical relay apparatus.

FIG. 4 is a configuration diagram illustrating an outline configuration example of an optical relay apparatus according to the example embodiment.

FIG. 5 is a configuration diagram illustrating another outline configuration example of the optical relay apparatus according to the example embodiment.

FIG. 6 is a configuration diagram illustrating a configuration example of an optical relay apparatus according to a first example embodiment.

FIG. 7 is a configuration diagram illustrating a configuration example of a coherent receiver front-end unit according to the first example embodiment.

FIG. 8 is a configuration diagram illustrating a configuration example of a coherent transmitter front-end unit according to the first example embodiment.

FIG. 9 is a configuration diagram illustrating a configuration example of a local oscillation light selection unit according to a first specific example of the first example embodiment.

FIG. 10 is a sequence diagram illustrating an operation example of the optical relay apparatus according to the first specific example of the first example embodiment.

FIG. 11 is a configuration diagram illustrating a configuration example of a local oscillation light selection unit according to a second specific example of the first example embodiment.

FIG. 12 is a sequence diagram illustrating an operation example of the optical relay apparatus according to the second specific example of the first example embodiment.

FIG. 13 is a configuration diagram illustrating a configuration example of a local oscillation light selection unit according to a third specific example of the first example embodiment.

FIG. 14 is a sequence diagram illustrating an operation example of the optical relay apparatus according to the third specific example of the first example embodiment.

FIG. 15 is a configuration diagram illustrating a configuration example of an optical relay apparatus according to a second example embodiment.

FIG. 16 is a configuration diagram illustrating another configuration example of the optical relay apparatus according to the second example embodiment.

FIG. 17 is a configuration diagram illustrating a configuration example of a transmission light selection unit according to a first specific example of the second example embodiment.

FIG. 18 is a sequence diagram illustrating an operation example of the optical relay apparatus according to the first specific example of the second example embodiment.

FIG. 19 is a configuration diagram illustrating a configuration example of a transmission light selection unit according to a second specific example of the second example embodiment.

FIG. 20 is a sequence diagram illustrating an operation example of the optical relay apparatus according to the second specific example of the second example embodiment.

FIG. 21 is a configuration diagram illustrating a configuration example of a transmission light selection unit according to a third specific example of the second example embodiment.

FIG. 22 is a sequence diagram illustrating an operation example of the optical relay apparatus according to the third specific example of the second example embodiment.

FIG. 23 is a configuration diagram illustrating a configuration example of an optical relay apparatus according to a third example embodiment.

FIG. 24 is a configuration diagram illustrating another configuration example of the optical relay apparatus according to the third example embodiment.

FIG. 25A is a sequence diagram illustrating an operation example of the optical relay apparatus according to a fourth example embodiment.

FIG. 25B is a sequence diagram illustrating an operation example of the optical relay apparatus according to the fourth example embodiment.

FIG. 26A is a sequence diagram illustrating another operation example of the optical relay apparatus according to the fourth example embodiment.

FIG. 26B is a sequence diagram illustrating another operation example of the optical relay apparatus according to the fourth example embodiment.

### EXAMPLE EMBODIMENT

Hereinafter, example embodiments will be described with reference to the drawings. In the drawings, the same or associated elements are denoted by the same reference numeral, and redundant description thereof is omitted as necessary for clarity of description. An arrow illustrated in the drawings is an illustrative example, and does not limit a type or direction of a signal.

### Outline of Example Embodiment

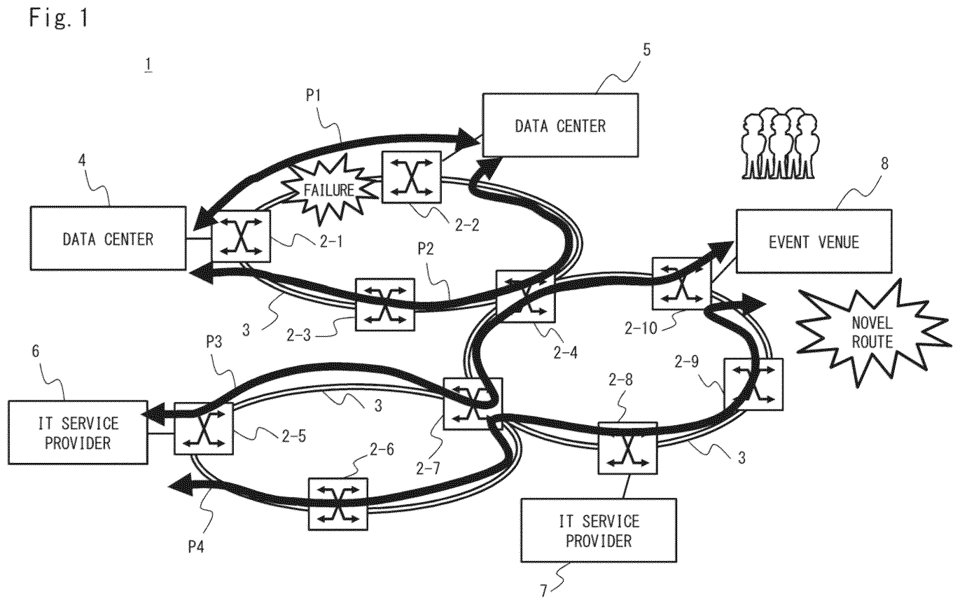

First, an outline of an example embodiment will be described. FIG. 1 illustrates a configuration example of an optical transmission system 1 according to an example embodiment. The optical transmission system 1 according to the example embodiment is, for example, a backbone wavelength multiplex optical transmission system, and performs large capacity communication in excess of 100 Gbps or in a class of 1 Tbps by performing wavelength multiplexing and performing digital coherent transmission on optical signals of wavelengths. According to wavelength multiplexing, a frequency utilization efficiency of light can be improved, and it is possible to respond to mobile traffic and wavelength defragmentation. In addition, since a transmission route or a wavelength path can be flexibly switched as an optical signal by wavelength multiplexing, the infrastructure can be maintained by switching and bypassing the transmission line at the time of transmission congestion or failure.

As illustrated in FIG. 1, the optical transmission system 1 includes a plurality of optical relay apparatuses 2 (e.g., 2-1 to 2-10) that are connected via an optical fiber transmission line 3 in such a way as to be able to optically communicate. The optical relay apparatus 2 is a photonic node capable of relaying a wavelength-multiplexed optical signal, and for example, is a ROADM device. In this example, the optical relay apparatuses 2-1 to 2-10 constitute a ring-type network including three rings, but may constitute a network of other topologies.

A wavelength path is allocated to each optical relay apparatus 2, and traffic of the accommodated local network or another optical relay apparatus 2 is transferred via the allocated wavelength path. For example, the optical relay apparatus 2-1 accommodates a network of a data center 4, and the optical relay apparatus 2-2 accommodates a network of a data center 5, and a large capacity traffic such as a video distribution service for distributing high-quality video (4 k/8 k) is transferred. For example, if a failure occurs in the wavelength path P1 while the optical relay apparatus 2-1 and the optical relay apparatus 2-2 are transferring traffic between the data center 4 and the data center 5 via the wavelength path P1, the wavelength path Pl is switched to the wavelength path P2. As a result, the transfer of the traffic between the data center 4 and the data center 5 can be maintained via a bypass route including the optical relay apparatus 2-3 and the optical relay apparatus 2-4.

However, there is a possibility the wavelengths may collide with each other in the optical relay apparatus of the switching destination in the event that the wavelength path P1 is switched to the wavelength path P2. For example, it is assumed that a wavelength λ1 is set to the wavelength path P1 between the optical relay apparatus 2-1 and the optical relay apparatus 2-2, and a wavelength λ1 is also set to the wavelength path P3 between the optical relay apparatus 2-5 and the optical relay apparatus 2-10. Then, in the event that the wavelength path P1 is switched to the wavelength path P2, the wavelength λ1 of the wavelength path P3 being transferred in the optical relay apparatus 2-4 collides with the wavelength λ1 of the switched wavelength path P2. In this case, a method of avoiding collision by switching the wavelength path P3 to another route is conceivable, but the wavelength slot of another route is not necessarily empty. Therefore, it is necessary to convert the wavelength of the wavelength path relayed by the optical relay apparatus 2-4. For example, in the wavelength path P2, the optical relay apparatus 2-4 converts the optical signal having the wavelength λ1 received from the optical relay apparatus 2-3 into the optical signal having the wavelength λ2 and transmits the optical signal to the optical relay apparatus 2-2. This makes it possible to avoid collision of wavelengths in the event that the wavelength path is switched to the bypass route.

Furthermore, for example, the optical relay apparatus 2-5 accommodates the IoT sensor network of an IT service provider 6, the optical relay apparatus 2-7 accommodates the IoT sensor network of an IT service provider 7, and the optical relay apparatus 2-8 accommodates the mobile network of an event venue 8. Traffic of the mobile network is a spot demand traffic by a moving user. For example, if a spot demand traffic newly occurs in the event venue 8 while the optical relay apparatus 2-5 and the optical relay apparatus 2-10 are transferring traffic between the IT service provider 6 and the event venue 8 via the wavelength path P3 including the optical relay apparatus 2-7 and the optical relay apparatus 2-4, a wavelength path P4 is newly set. As a result, the traffic generated in the event venue 8 can be transferred via the optical relay apparatus 2-6, the optical relay apparatus 2-7, the optical relay apparatus 2-8, and the optical relay apparatus 2-9.

However, in this case as well, similarly to the case where the route of the wavelength path is switched, there is a possibility that the wavelengths may collide with each other in the optical relay apparatus to which the wavelength path is newly set. For example, it is assumed that the wavelength λ1 is set in the wavelength path P3 between the optical relay apparatus 2-5 and the optical relay apparatus 2-10. Then, in the event that the wavelength λ1 is also newly set to the wavelength path P4 allocated between the optical relay apparatus 2-5 and the optical relay apparatus 2-10, the wavelength λ1 of the wavelength path P3 being transferred by the optical relay apparatus 2-7 collides with the wavelength λ1 of the new wavelength path P4. Therefore, in this case as well, it is necessary to convert the wavelength of the wavelength path relayed by the optical relay apparatus 2-7. For example, in the wavelength path P4, the optical relay apparatus 2-7 converts the optical signal having the wavelength λ1 received from the optical relay apparatus 2-6 into the optical signal having the wavelength λ2 and transmits the optical signal to the optical relay apparatus 2-8. This makes it possible to avoid collision of wavelengths in newly setting the wavelength path.

As described above, if a failure occurs in a wavelength path and there is a path having the same wavelength in the bypass route upon setting the bypass route, wavelength conversion needs to be performed, and in a case where there is a path having the same wavelength in an existing route upon setting a new route, the wavelength conversion needs to be performed. Therefore, the inventor has studied a wavelength conversion method in an optical relay apparatus, and has found a problem that it takes several seconds to several tens of seconds to switch a wavelength to be converted depending on a wavelength switching time of a light source and a time of automatic bias voltage control of an optical modulator in a related art although quick switching of wavelength conversion is required in any case described above.

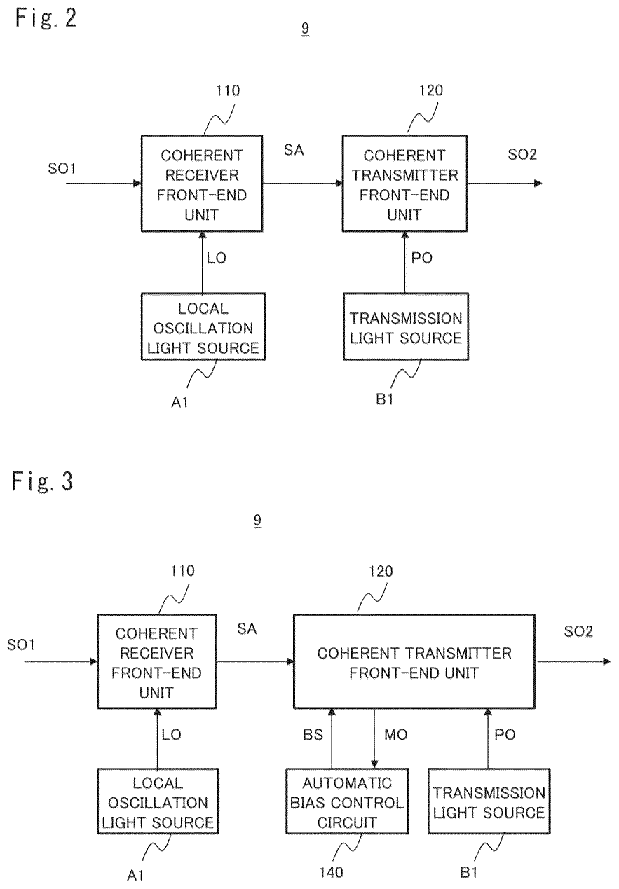

FIG. 2 illustrates a configuration example of the related optical relay apparatus 9. In this example, as a wavelength conversion method for suppressing an increase in latency that occurs at the time of conversion of the wavelength of the optical signal, the optical signal detected by the coherent receiver front-end unit is achieved by the coherent transmitter front-end unit performing optical modulation again with another wavelength.

As illustrated in FIG. 2, the related optical relay apparatus 9 includes a coherent receiver front-end unit 110 and a coherent transmitter front-end unit 120. The coherent receiver front-end unit 110 coherently detects an input optical signal SOI received from the optical relay apparatus of the preceding stage by the local oscillation light (local oscillation light) LO of a predetermined wavelength from a local oscillation light source A1 that is a wavelength variable light source, and outputs the detected analog electric signal SA to the coherent transmitter front-end unit 120.

The coherent transmitter front-end unit 120 optically modulates (coherently modulates) the analog electric signal SA coherently detected by the coherent receiver front-end unit 110 with the transmission light PO having a predetermined wavelength from a transmission light source B1 that is a wavelength variable light source, and transmits a generated output optical signal SO2 to the optical relay apparatus of the subsequent stage. The related optical relay apparatus 9 includes an analog circuit that does not perform digital processing, so that wavelength conversion can be achieved with low delay and at low cost.

However, in the related technology, it is necessary to switch the wavelength of the local oscillation light LO of the local oscillation light source A1 or the wavelength of the transmission light PO of the transmission light source B1 upon switching the wavelength to be converted (the wavelength before conversion or the wavelength after conversion of the optical relay apparatus), but a problem arises in that the wavelength switching of the wavelength variable light source requires several seconds to several tens of seconds.

Furthermore, as illustrated in FIG. 3, in the related optical relay apparatus 9, an automatic bias control circuit (ABC circuit; Automatic Bias Control circuit) 140 performs a bias voltage control of the modulator of the coherent transmitter front-end unit 120. However, since the automatic bias control circuit 140 monitors a monitor signal MO from the modulator of the coherent transmitter front-end unit 120 and sets the optimum bias voltage BS according to the monitoring result, if the optical power input to the modulator fluctuates or is not input, or if the electric signal for driving the modulator becomes no signal, the bias voltage cannot be correctly controlled. Therefore, after the wavelength is switched and the optical power and the electric signal become normal again, it takes several seconds to a maximum of several tens of seconds until the control is correctly performed and the optimum bias voltage is obtained.

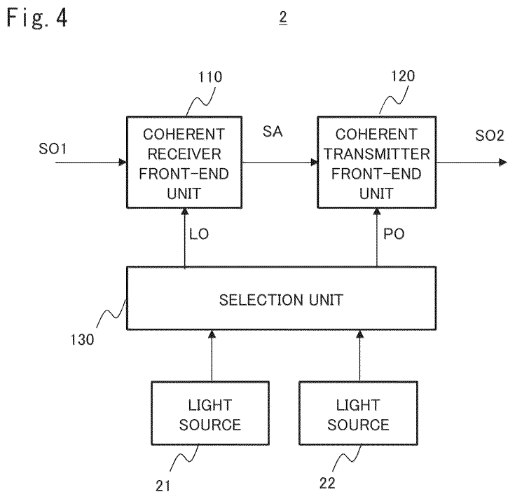

Therefore, at least one of these problems can be solved in the example embodiment. FIG. 4 illustrates an example of a schematic configuration of the optical relay apparatus 2 according to the example embodiment. In the example of FIG. 4, the optical relay apparatus 2 according to the example embodiment includes a coherent receiver front-end unit 110, a coherent transmitter front-end unit 120, a light source 21, a light source 22, and a selection unit 130.

The coherent receiver front-end unit 110 and the coherent transmitter front-end unit 120 have configurations similar to those in FIG. 2. That is, the coherent receiver front-end unit 110 is an optical-to-electrical conversion unit for converting an optical signal into an electric signal, and is a coherent detection unit for performing coherent detection. The coherent receiver front-end unit 110 performs coherent detection on the input optical signal SO1 to be input based on the local oscillation light LO, and outputs the generated analog electric signal SA.

The coherent transmitter front-end unit 120 is an electrical-to-optical conversion unit for converting an electric signal into an optical signal, and is a coherent modulation unit for performing coherent modulation. The coherent transmitter front-end unit 120 coherently modulates the analog electric signal SA generated by the coherent receiver front-end unit 110 based on the transmission light PO, and outputs the generated output optical signal SO2. A signal based on the analog electric signal SA generated by the coherent receiver front-end unit 110 may be input to the coherent transmitter front-end unit 120. For example, a signal obtained by performing signal processing such as predetermined compensation processing on the analog electric signal SA by an analog circuit or a digital circuit may be input to the coherent transmitter front-end unit 120.

The frequency (wavelength) of the local oscillation light LO is the frequency (wavelength) of the input optical signal SO1 to be received, and the frequency of the transmission light PO is the frequency of the output optical signal SO2 to be transmitted. The “frequency” of the signal or the “wavelength” of the signal will be described, but the “frequency” and the “wavelength” can be read as each other. For example, the local oscillation light LO and the transmission light PO have different frequencies, but may have the same frequency. The wavelength of the optical signal can be switched by changing the frequencies of the local oscillation light LO and the transmission light PO. That is, the input optical signal SO1 can be converted into the output optical signal SO2 having a different wavelength.

The light source 21 (first light source) outputs first light having a first wavelength. The light source 22 (second light source) outputs second light having a second wavelength. The light sources 21 and 22 are local oscillation light sources that output local oscillation light or transmission light sources that output transmission light. For example, the light sources 21 and 22 are wavelength variable light sources in which the wavelength of light to be output can be changed, but may be wavelength fixed light sources in which the wavelength of light to be output is fixed. Not limited to the two light sources 21 and 22, a plurality of light sources may be further provided.

The selection unit 130 selects either the first light having the first wavelength output from the light source 21 or the second light having the second wavelength output from the light source 22, and outputs the selected light as the local oscillation light LO or the transmission light PO. The selection unit 130 may output either the local oscillation light LO or the transmission light PO, or may output both the local oscillation light LO and the transmission light PO. For example, either the first light or the second light may be output to the coherent receiver front-end unit 110 as the local oscillation light LO, or either the first light or the second light may be output to the coherent transmitter front-end unit 120 as the transmission light PO. For example, the selection unit 130 may include an optical switch, or may include a variable attenuator and an optical coupler.

In the example of FIG. 4, the lights output from the two light sources are selected by a selection unit such as an optical switch, and the wavelength of the local oscillation light or the transmission light is switched. As a result, as compared with a case where the wavelength of the local oscillation light or the transmission light is switched by one wavelength variable light source as illustrated in FIG. 2, the switching time of the wavelength to be converted can be shortened, and the speed of wavelength switching can be increased.

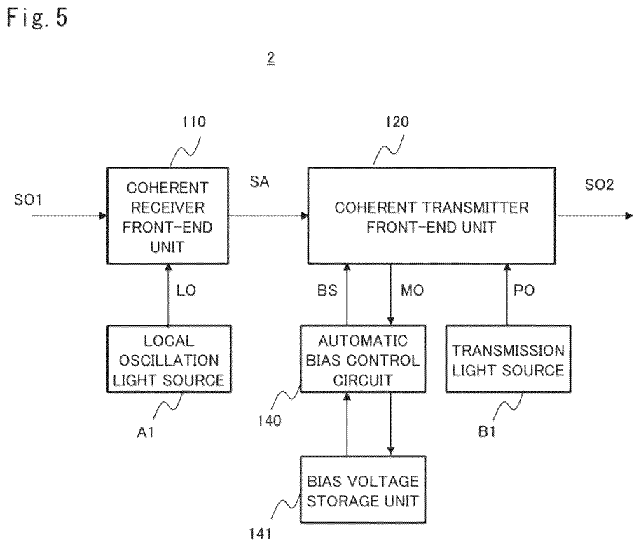

FIG. 5 illustrates another example of the schematic configuration of the optical relay apparatus 2 according to the example embodiment. In the example of FIG. 5, the optical relay apparatus 2 according to the example embodiment includes the coherent receiver front-end unit 110, the coherent transmitter front-end unit 120, the automatic bias control circuit 140, and a bias voltage storage unit 141. The optical relay apparatus 2 according to the example embodiment may include the configuration of FIG. 4 and the configuration of FIG. 5. For example, the optical relay apparatus 2 may further include the bias voltage storage unit 141 in the configuration of FIG. 4.

The automatic bias control circuit 140 has a configuration similar to that of FIG. 3, and automatically controls the bias voltage BS for the modulator of the coherent transmitter front-end unit 120. The automatic bias control circuit 140 monitors the monitor signal MO of the modulator of the coherent transmitter front-end unit 120, and performs optimization control (automatic bias control processing) of the bias voltage BS to be set to the modulator of the coherent transmitter front-end unit 120 according to the monitoring result. For example, the automatic bias control circuit 140 stops (temporarily stops) the automatic bias control processing before switching the wavelength of the local oscillation light LO or the transmission light PO, and resumes the automatic bias control processing after completion of the wavelength switching of the local oscillation light LO or the transmission light PO. For example, in a case where the selection unit 130 in FIG. 4 switches the wavelength of the local oscillation light LO or the transmission light PO, the automatic bias control circuit 140 may stop the automatic bias control processing before switching the light selected by the selection unit 130, and resume the automatic bias control processing after switching the light selected by the selection unit 130.

The bias voltage storage unit 141 stores a bias voltage BS (bias voltage optimized by automatic bias control) before (immediately before) switching the wavelength of the local oscillation light LO or the transmission light PO. After completion of the wavelength switching of the local oscillation light LO or the transmission light PO, the automatic bias control circuit 140 resumes the automatic bias control processing using the bias voltage BS stored in the bias voltage storage unit 141. For example, in a case where the selection unit 130 in FIG. 4 switches the wavelength of the local oscillation light LO or the transmission light PO, the bias voltage BS before (immediately before) switching the light selected by the selection unit 130 is stored, and after switching the light selected by the selection unit 130, the automatic bias control circuit 140 may resume the automatic bias control processing using the bias voltage BS stored in the bias voltage storage unit 141.

In the example of FIG. 5, the bias voltage of the automatic bias control circuit is stored before the wavelength to be converted is switched, and the automatic bias control is resumed using the stored bias voltage after the wavelength switching is completed. As a result, the time from switching the wavelength to be converted until the bias voltage is optimized can be shortened.

### FIRST EXAMPLE EMBODIMENT

Next, a first example embodiment will be described. In the present example embodiment, an example in which any of a plurality of local oscillation light sources is selected and a wavelength of local oscillation light is switched will be described. The configuration of the optical transmission system 1 according to the present example embodiment is similar to that of FIG. 1.

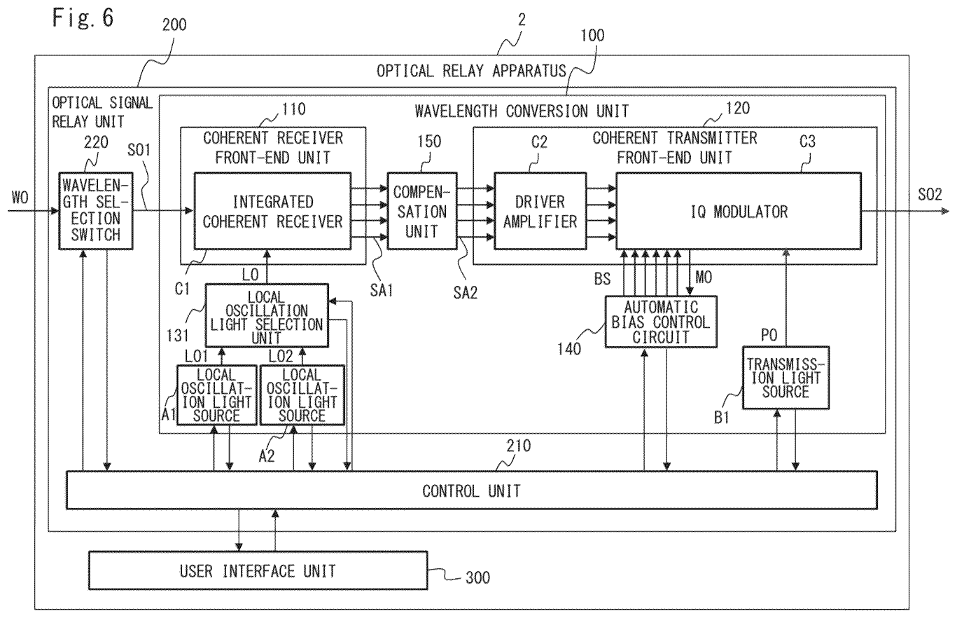

FIG. 6 illustrates a configuration example of the optical relay apparatus 2 according to the present example embodiment. As illustrated in FIG. 6, the optical relay apparatus 2 according to the present example embodiment includes a wavelength conversion unit 100, a control unit 210, a wavelength selective switch 220, and a user interface unit 300. For example, the wavelength conversion unit 100, the control unit 210, and the wavelength selective switch 220 constitute an optical signal relay unit 200 for converting and relaying a predetermined wavelength. The optical relay apparatus 2 may include a plurality of optical signal relay units 200.

In this example, the optical signal relay unit 200 receives a wavelength multiplex signal WO from the optical relay apparatus 2 at the preceding stage via the optical fiber transmission line 3. For example, the wavelength multiplex signal WO may be input to the optical signal relay unit 200 after being wavelength separated from the optical fiber transmission line 3 via a coupler (demultiplexer) or another wavelength selective switch.

The wavelength selective switch 220 is a switch for selecting and outputting an optical signal having a predetermined wavelength from the input optical signal. The wavelength selective switch 220 selects an optical signal having a wavelength set from the control unit 210. For example, the wavelength selective switch 220 selects and extracts a predetermined one wavelength from the input wavelength multiplex signal WO, and outputs the extracted optical signal of the single channel as the input optical signal SO1.

The wavelength conversion unit 100 converts the wavelength of the input optical signal SO1 input from the wavelength selective switch 220, and outputs the output optical signal SO2 after wavelength conversion to the optical relay apparatus 2 at the subsequent stage via the optical fiber transmission line 3. For example, the output optical signal SO2 may be wavelength multiplexed via a coupler (multiplexer) or another wavelength selective switch and then output to the optical fiber transmission line 3.

The wavelength conversion unit 100 includes the coherent receiver front-end unit 110, the coherent transmitter front-end unit 120, local oscillation light sources A1 and A2, a local oscillation light selection unit 131, a transmission light source B1, an automatic bias control circuit 140, and a compensation unit 150.

The local oscillation light source A1 (e.g., first light source) generates the local oscillation light LO1 having the first wavelength, and outputs the generated local oscillation light LO1 to the local oscillation light selection unit 131. The local oscillation light source A2 (e.g., second light source) generates the local oscillation light LO2 having the second wavelength, and outputs the generated local oscillation light LO2 to the local oscillation light selection unit 131. For example, the local oscillation light sources A1 and A2 are wavelength variable light sources, and generate and output local oscillation lights LO1 and LO2 having wavelengths set by the control unit 210. The local oscillation light sources A1 and A2 are not limited to wavelength variable light sources, and may generate local oscillation lights LO1 and LO2 having preset fixed wavelengths, respectively. For example, a plurality of wavelength fixed light sources of two or more may be provided as the local oscillation light source.

The local oscillation light selection unit 131 (e.g., first selection unit) selects either the local oscillation light LO1 or the local oscillation light LO2 input from the local oscillation light sources A1 and A2, and outputs the selected light to the coherent receiver front-end unit 110 as the local oscillation light LO. The local oscillation light selection unit 131 selects local oscillation light of any local oscillation light source according to a control from the control unit 210. If the local oscillation light sources A1 and A2 are wavelength variable light sources and the local oscillation light source A1 is switched to the local oscillation light source A2, the local oscillation light selection unit 131 may select and output the local oscillation light LO2 of the local oscillation light source A2 after the wavelength switching of the local oscillation light source A2 is completed. For example, the local oscillation light selection unit 131 may be configured by an optical switch, may be configured by a variable optical attenuator and an optical coupler, or may have other configurations.

The transmission light source B1 generates transmission light PO having a predetermined wavelength, and outputs the generated transmission light PO to the coherent transmitter front-end unit 120. For example, the transmission light source B1 is a wavelength variable light source, and generates and outputs transmission light PO having a wavelength set by the control unit 210.

Similarly to FIG. 4, the coherent receiver front-end unit 110 coherently detects the input optical signal SO1 to be input by the local oscillation light LO from the local oscillation light selection unit 131, converts it to an analog electric signal SA1, and outputs the analog electric signal SA1. For example, the coherent receiver front-end unit 110 includes an integrated coherent receiver C1.

In addition, the coherent transmitter front-end unit 120 coherently modulates the analog electric signal SA2 converted by the coherent receiver front-end unit 110 and subjected to the signal processing by the compensation unit 150 with the transmission light PO from the transmission light source B1, converts it to the output optical signal SO2, and outputs the output optical signal SO2. For example, the coherent transmitter front-end unit 120 includes a driver amplifier C2 and an IQ modulator C3.

For example, the input optical signal SO1 and the output optical signal SO2 are optical signals subjected to phase modulation and polarization multiplexing. Furthermore, the analog electric signals SA1 and SA2 are signals of four lanes (4 ch) including an XI signal which is an I component (in-phase component) of the X polarized wave, an XQ signal which is a Q component (orthogonal component) of the X polarized wave, a YI signal which is an I component of the Y polarized wave, and a YQ signal which is a Q component of the Y polarized wave.

The compensation unit 150 is a circuit configured to perform compensation processing of compensating for signal distortion on the analog electric signal SAI between the coherent receiver front-end unit 110 and the coherent transmitter front-end unit 120, and generate a compensation processed analog electric signal SA2. The compensation processing may be analog signal processing by an analog circuit or may include digital signal processing by a digital circuit. The compensation processing is a processing of compensating for distortion (quality) of a signal to be transmitted, and is, for example, frequency compensation, skew compensation, amplitude compensation, or the like.

Similarly to FIG. 5, the automatic bias control circuit 140 monitors the monitor signal MO of the IQ modulator C3 of the coherent transmitter front-end unit 120, and performs optimization control (automatic bias control processing) of the bias voltage BS to be set to the IQ modulator C3 according to the monitoring result. For example, the automatic bias control circuit 140 starts, stops, and temporarily stops the automatic bias control processing according to the control from the control unit 210.

The control unit 210 collectively controls each of the units constituting the optical signal relay unit 200. The control unit 210 includes a setting information acquisition unit configured to acquire setting information from the user interface unit 300. Furthermore, the control unit 210 includes a setting unit or an instruction unit for performing setting or an instruction to each of the wavelength selective switch 220, the local oscillation light sources A1 and A2, the local oscillation light selection unit 131, the transmission light source B1, and the like in accordance with the setting information or an instruction from the user interface unit 300.

For example, in a case where the wavelength of the input optical signal SO1 is set or switched, the control unit 210 controls the operations of the wavelength selective switch 220, the local oscillation light sources A1 and A2, and the local oscillation light selection unit 131. In the control with respect to the wavelength selective switch 220, the control unit 210 sets the wavelength of the optical signal selected by the wavelength selective switch 220 based on the setting information or the wavelength change instruction acquired from the user interface unit 300. The control unit 210 may set the wavelength of the optical signal to be selected based not only on the setting information acquired from the user interface unit 300 but also on the setting information registered in advance in the optical signal relay unit 200.

In the control with respect to the local oscillation light sources A1 and A2, if the local oscillation light sources A1 and A2 are wavelength variable light sources, the control unit 210 sets the wavelengths of the local oscillation lights LO1 and LO2 output from the local oscillation light sources A1 and A2 based on the setting information and the wavelength change instruction acquired from the user interface unit 300. The control unit 210 may set the wavelengths of the local oscillation lights LO1 and LO2 based not only on the setting information acquired from the user interface unit 300 but also on the setting information registered in advance in the optical signal relay unit 200. The wavelengths of the local oscillation lights LO1 and LO2 output from the local oscillation light sources A1 and A2 may be monitored by a wavemeter or the like, and whether the wavelength control with respect to the local oscillation light sources A1 and A2 has been completed may be determined according to the monitoring results of the wavelengths of the local oscillation lights LO1 and LO2.

In the control with respect to the local oscillation light selection unit 131, the control unit 210 controls the local oscillation light selected by the local oscillation light selection unit 131 based on the setting information and the wavelength change instruction acquired from the user interface unit 300.

For example, in a case where the wavelength of the output optical signal SO2 is set or switched, the control unit 210 controls the operation of the transmission light source B1. In the control with respect to the transmission light source B1, the control unit 210 sets the wavelength of the transmission light PO output from the transmission light source B1 based on the setting information or the wavelength change instruction acquired from the user interface unit 300. The control unit 210 may set the wavelength of the transmission light PO based not only on the setting information acquired from the user interface unit 300 but also on the setting information registered in advance in the optical signal relay unit 200. The wavelength of the transmission light PO output from the transmission light source B1 may be monitored by a wavemeter or the like, and whether the wavelength control with respect to the transmission light source B1 has been completed may be determined according to the monitoring result of the wavelength of the transmission light PO.

The user interface unit 300 is an interface for a user (operator) who performs setting and management of the optical relay apparatus 2 and the optical signal relay unit 200. The user interface unit 300 may include an operation unit operated by the user, a display unit configured to display information to the user, and the like as necessary. For example, the user interface unit 300 transmits setting information, wavelength change instruction, and the like for each unit of the optical signal relay unit 200 to the control unit 210. The user interface unit 300 may transmit the setting information, the wavelength change instruction, or the like in response to an input from the user, or may transmit the setting information, the wavelength change instruction, or the like based on information stored in a database or the like in advance.

The user interface unit 300 may be disposed inside the optical relay apparatus 2 or may be disposed outside the optical relay apparatus 2. The user interface unit 300 can also be achieved, for example, as one function of a network control device configured to control the entire optical transmission system 1 including the optical relay apparatus 2. As an example of the network control device, a network management system (NMS) for controlling and managing a path and a wavelength of the optical transmission system 1 may be used.

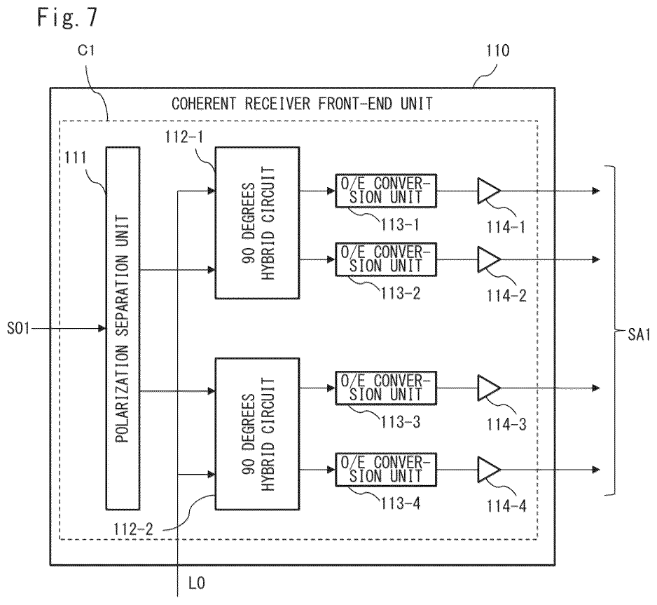

FIG. 7 illustrates a configuration example of the coherent receiver front-end unit 110 according to the present example embodiment. As illustrated in FIG. 7, the coherent receiver front-end unit 110 includes a polarization separation unit 111, 90 degree hybrid circuits 112-1 to 112-2, O/E conversion units 113-1 to 113-4, and amplifiers 114-1 to 114-4. For example, the polarization separation unit 111, the 90 degree hybrid circuits 112-1 to 112-2, the O/E conversion units 113-1 to 113-4, and the amplifiers 114-1 to 114-4 constitute the integrated coherent receiver C1.

The polarization separation unit 111 polarization-separates the input optical signal SO1, which is a polarization multiplexing signal input from the wavelength selective switch 220, into an X polarized wave and a Y polarized wave. The 90 degree hybrid circuits (coherent optical detectors) 112-1 to 112-2 perform coherent detection by interfering the optical signal polarization-separated by the polarization separation unit 111 with the local oscillation light LO selected by the local oscillation light selection unit 131. The O/E conversion units 113-1 to 113-4 including a photo diode or the like convert the coherently detected signal into analog electric signals of four lanes.

The 90 degree hybrid circuit 112-1 separates the X polarized wave of the input optical signal SO1 into an I component and a Q component, and then performs photoelectric conversion by the O/E conversion units 113-1 to 113-2 to generate an XI signal and an XQ signal. The 90 degree hybrid circuit 112-2 separates the Y polarized wave of the input optical signal SO1 into an I component and a Q component, and then performs photoelectric conversion by the O/E conversion units 113-3 to 113-4 to generate a YI signal and a YQ signal.

The amplifiers 114-1 to 114-4 amplify the generated XI signal, XQ signal, YI signal, and YQ signal, respectively, and output the amplified signals to the compensation unit 150 as analog electric signals SAI of four lanes.

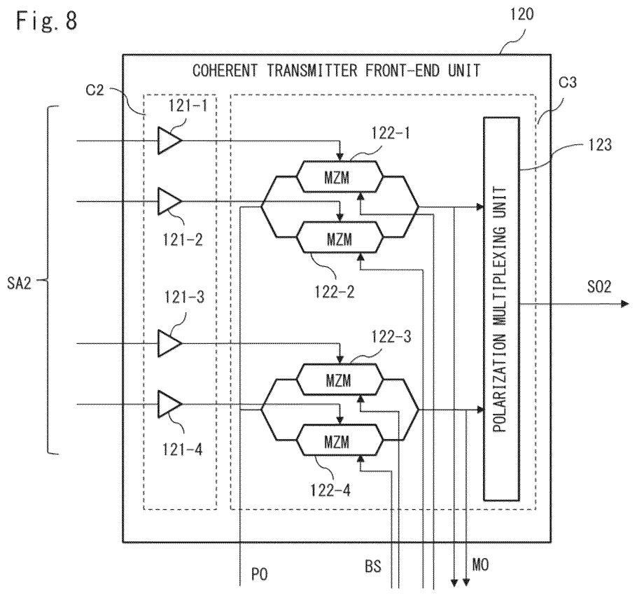

FIG. 8 illustrates a configuration example of the coherent transmitter front-end unit 120 according to the present example embodiment. As illustrated in FIG. 8, the coherent transmitter front-end unit 120 includes amplifiers 121-1 to 121-4, MZ modulators (MZM: Mach-Zehnder Modulators) 122-1 to 122-4, and a polarization multiplexing unit 123. For example, the amplifiers 121-1 to 121-4 constitute a driver amplifier C2. The MZ modulators 122-1 to 122-4 and the polarization multiplexing unit 123 constitute an IQ modulator C3.

The amplifiers 121-1 to 121-4 amplify the XI signal, the XQ signal, the YI signal, and the YQ signal of the analog electric signal SA2 output from the compensation unit 150, respectively, and drive the MZ modulators 122-1 to 122-4. The MZ modulators (IQ optical modulators) 122-1 to 122-4 apply IQ modulation to the transmission light PO from the transmission light source B1 according to the applied XI signal, XQ signal, YI signal, and YQ signal, respectively. The bias voltage BS from the automatic bias control circuit 140 is applied to the MZ modulators 122-1 to 122-2.

The MZ modulators 122-1 to 122-2 generate an IQ modulation optical signal of the X polarized wave based on the XI signal and the XQ signal via the amplifiers 121-1 to 121-2. The MZ modulators 122-3 to 122-4 generate an IQ modulation optical signal of the Y polarized wave based on the YI signal and the YQ signal via the amplifiers 121-3 to 121-4. A monitor signal MO for monitoring the power of the generated IQ modulation optical signal of the X polarized wave and the IQ modulation optical signal of the Y polarized wave is output to the automatic bias control circuit 140. The polarization multiplexing unit 123 polarization-multiplexes the generated IQ modulation optical signal of the X polarized wave and the IQ modulation optical signal of the Y polarized wave, and outputs the multiplexed optical signal as the output optical signal SO2.

### First Specific Example of First Example Embodiment

Next, a first specific example of the first example embodiment will be described. In the present first specific example, an optical switch is used as the local oscillation light selection unit 131.

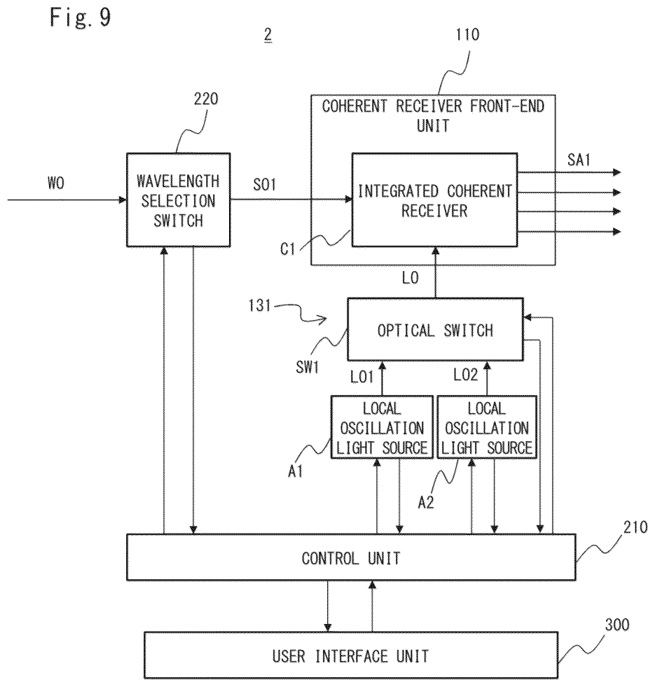

FIG. 9 illustrates a configuration example of the local oscillation light selection unit 131 according to the present first specific example. As illustrated in FIG. 9, in the present first specific example, the local oscillation light selection unit 131 includes an optical switch SW1. Furthermore, in the present first specific example, the local oscillation light sources A1 and A2 are wavelength variable light sources.

The optical switch SW1 is a local oscillation light selection switch and is a 2×1 optical switch (2 input−1 output optical switch). The optical switch SW1 selects either the local oscillation light LO1 or LO2 input from the local oscillation light sources A1 and A2, and outputs the selected light to the coherent receiver front-end unit 110 as the local oscillation light LO. The optical switch SW1 switches the local oscillation light LO to be output from the input light in response to an instruction from the control unit 210.

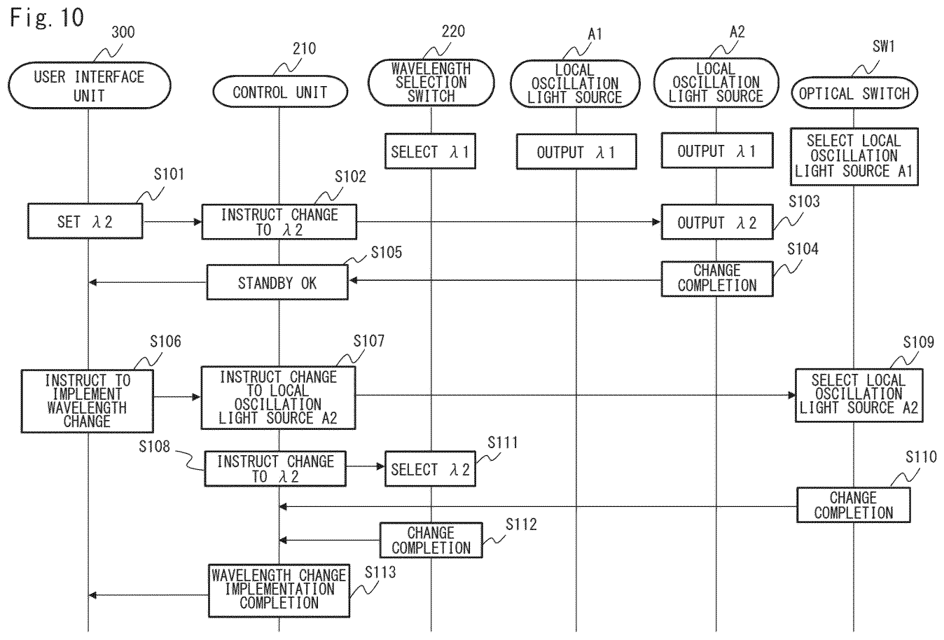

FIG. 10 illustrates an operation example of the present first specific example. FIG. 10 illustrates an operation example in a case where the wavelength of the input optical signal SO1 is switched from λ1 to λ2. FIG. 10 is an example, and in a case where the local oscillation light source A1 outputs the local oscillation light LO1 having the wavelength 21 and the local oscillation light source A2 outputs the local oscillation light source LO2 having the wavelength λ2, S102 to S106 may be omitted. In this case, the user interface unit 300 may set the wavelength information (λ2) of the next input optical signal SO1 to the control unit 210 (S101), and the control unit 210 may instruct the optical switch SW1 to change the selection of the input signal to the local oscillation light source A2 side (S107).

In the example of FIG. 10, first, the wavelength of the input optical signal SO1 is operated at λ1. Specifically, λ1 is set as the selected wavelength of the wavelength selective switch 220, and the wavelength selective switch 220 selects the optical signal having the wavelength λ1 from the wavelength multiplex signal WO and outputs the selected optical signal having the wavelength λ1 as the input optical signal SO1.

In addition, the wavelengths of the local oscillation light sources A1 and A2 are set to λ1, and the local oscillation light LO1 having the wavelength λ1 and the local oscillation light LO1 having the wavelength λ1 are output from the local oscillation light sources A1 and A2. The optical switch SW1 is set to select the local oscillation light LO1 on the local oscillation light source A1 side, and the local oscillation light LO1 having the wavelength λ1 is output from the optical switch SW1. The coherent receiver front-end unit 110 coherently detects the input optical signal SO1 having the wavelength λ1 input from the wavelength selective switch 220 by the local oscillation light LO1 having the wavelength λ1 from the optical switch SW1.

In this state, the user interface unit 300 sets the wavelength information (λ2) of the next input optical signal SO1 to the control unit 210 (S101). For example, before switching the wavelength of the input optical signal SO1, the user inputs the next wavelength λ2 to the user interface unit 300, and the user interface unit 300 sets the wavelength information of the input wavelength λ2.

Upon receiving the wavelength information (λ2) of the next input optical signal SO1 from the user interface unit 300, the control unit 210 instructs the local oscillation light source A2 (local oscillation light source not currently selected by the optical switch) to change the light output wavelength to λ2 (S102). Upon receiving the instruction to change the wavelength to λ2 from the control unit 210, the local oscillation light source A2 changes the wavelength of the local oscillation light LO2 to be output to the instructed wavelength λ2 (S103), and notifies the control unit 210 of the completion of the wavelength change (S104).

Upon receiving the completion of the wavelength change from the local oscillation light source A2, the control unit 210 notifies the user interface unit 300 of standby OK (S105). For example, the user interface unit 300 receives the standby OK from the control unit 210, and outputs (displays) to the user that the standby of the wavelength switching of the input optical signal SO1 is completed.

Thereafter, the user interface unit 300 instructs the control unit 210 to implement wavelength change of the input optical signal SO1 (S106). For example, after receiving the standby OK, the user inputs a wavelength change implementation instruction to the user interface unit 300 at any timing (timing to switch the wavelength of the input optical signal SO1), and the user interface unit 300 instructs the implementation of wavelength change.

Upon receiving the wavelength change implementation instruction of the input optical signal SO1 from the user interface unit 300, the control unit 210 instructs the optical switch SW1 to change the selection of the input signal to the local oscillation light source A2 side (S107). In addition, the control unit 210 instructs the wavelength selective switch 220 to change the selected wavelength to the wavelength λ2 (S108).

Upon receiving the instruction to change the selection of the input signal from the control unit 210, the optical switch SW1 switches to select and output the local oscillation light LO2 of the local oscillation light source A2 (S109), and notifies the control unit 210 of the change completion (S110). Furthermore, upon receiving the instruction to change the selected wavelength from the control unit 210, the wavelength selective switch 220 switches to select and output the wavelength λ2 (S111), and notifies the control unit 210 of the change completion (S112).

As a result, the wavelength selective switch 220 selects the optical signal having the wavelength λ2 from the wavelength multiplex signal WO, and outputs the selected optical signal having the wavelength λ2 as the input optical signal SO1. In addition, the optical switch SW1 outputs the local oscillation light LO2 having the wavelength λ2, and the coherent receiver front-end unit 110 coherently detects the input optical signal SO1 having the wavelength λ2 input from the wavelength selective switch 220 by the local oscillation light LO2 having the wavelength λ2 from the optical switch SW1.

Upon receiving the change completion of the input signal selection from the optical switch SW1 and receiving the change completion from the wavelength selective switch 220, the control unit 210 notifies the user interface unit 300 of the completion of the wavelength change implementation of the input optical signal SO1 (S113). For example, the user interface unit 300 receives the notification of the completion of the wavelength change implementation from the control unit 210, and outputs (displays) to the user that the wavelength change of the input optical signal SO1 is completed.

### Second Specific Example of First Example Embodiment

Next, a second specific example of the first example embodiment will be described. In the present second specific example, a variable optical attenuator and an optical coupler are used as the local oscillation light selection unit 131.

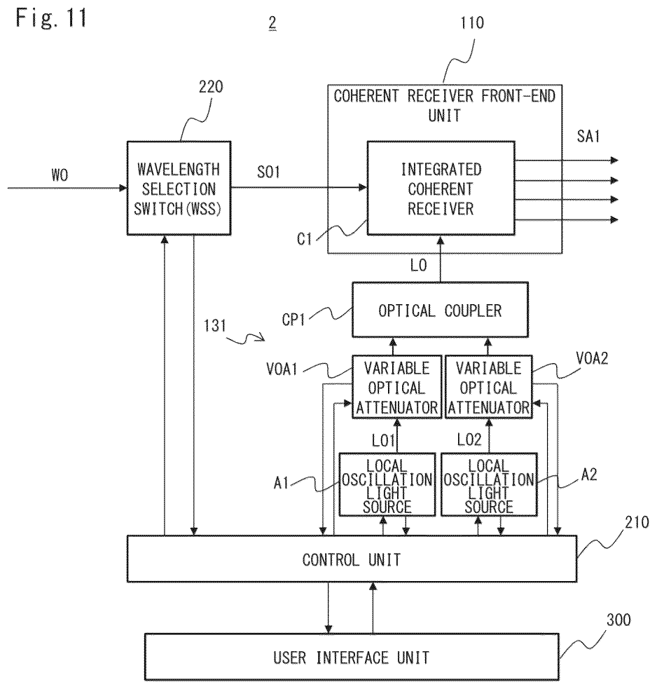

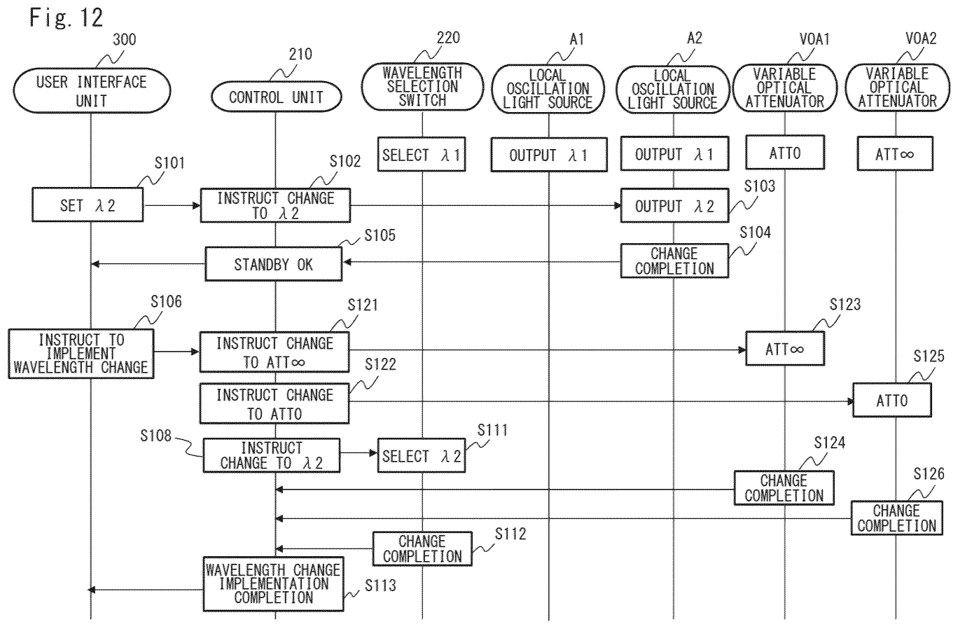

FIG. 11 illustrates a configuration example of the local oscillation light selection unit 131 according to the present second specific example. As illustrated in FIG. 11, in the present second specific example, the local oscillation light selection unit 131 includes variable optical attenuators VOA1 and VOA2 and an optical coupler CP1. Furthermore, in the present second specific example, the local oscillation light sources A1 and A2 are wavelength variable light sources.

The variable optical attenuator VOA1 (e.g., first variable attenuator) attenuates the optical power of the local oscillation light LO1 input from the local oscillation light source A1, and outputs the attenuated optical signal to the optical coupler CP1. The variable optical attenuator VOA1 attenuates the optical power of the local oscillation light LO1 by the attenuation amount set from the control unit 210. For example, if the attenuation amount is ∞ (infinity), the local oscillation light LO1 is not output from the variable optical attenuator VOA1.

Similarly to the variable optical attenuator VOA1, the variable optical attenuator VOA2 (e.g., second variable attenuator) attenuates the optical power of the local oscillation light LO2 input from the local oscillation light source A2, and outputs the attenuated optical signal to the optical coupler CP1. The variable optical attenuator VOA2 attenuates the optical power of the local oscillation light LO2 by the attenuation amount set from the control unit 210. For example, if the attenuation amount is ∞, the local oscillation light LO2 is not output from the variable optical attenuator VOA2.

The optical coupler (multiplexer) CP1 is a 1×2 optical coupler (1 input-2 output optical coupler), and multiplexes the local oscillation light LO1 and the local oscillation light LO2 input via the variable optical attenuators VOA1 and VOA2, and outputs the multiplexed light to the coherent receiver front-end unit 110 as the local oscillation light LO. Either the local oscillation light LO1 or the local oscillation light LO2 is output from the optical coupler CP1 by controlling the attenuation amounts of the variable optical attenuators VOA1 and VOA2. For example, in a case where the local oscillation light LO2 is not output from the variable optical attenuator VOA2 while the local oscillation light LOI is being output from the variable optical attenuator VOA1, the optical coupler CP1 outputs the local oscillation light LO1. In a case where the local oscillation light LO1 is not output from the variable optical attenuator VOA1 while the local oscillation light LO2 is being output from the variable optical attenuator VOA2, the optical coupler CP1 outputs the local oscillation light LO2.

FIG. 12 illustrates an operation example of the present second specific example. Similarly to FIG. 10, FIG. 12 illustrates an operation example in a case where the wavelength of the input optical signal SO1 is switched from λ1 to λ2. FIG. 12 is an example, and in a case where the local oscillation light source A1 outputs the local oscillation light LO1 having the wavelength λ1 and the local oscillation light source A2 outputs the local oscillation light source LO2 having the wavelength λ2, S102 to S106 may be omitted. In this case, the user interface unit 300 may set the wavelength information (22) of the next input optical signal SO1 to the control unit 210 (S101), and the control unit 210 may instruct the variable optical attenuator VOA1 to change the attenuation amount to ∞ (S121) and instruct the variable optical attenuator VOA2 to change the attenuation amount to 0 (S122).

In the example of FIG. 12, first, similarly to FIG. 10, the wavelength of the input optical signal SO1 is operated at λ1. Specifically, λ1 is set as the selected wavelength of the wavelength selective switch 220, and the wavelength selective switch 220 selects the optical signal having the wavelength λ1 from the wavelength multiplex signal WO and outputs the selected optical signal having the wavelength λ1 as the input optical signal SO1.

In addition, the wavelengths of the local oscillation light sources A1 and A2 are set to λ1, and the local oscillation light LO1 having the wavelength λ1 and the local oscillation light LO1 having the wavelength λ1 are output from the local oscillation light sources A1 and A2. The attenuation amount (ATT) of the variable optical attenuator VOA1 is set to 0, and the attenuation amount of the variable optical attenuator VOA2 is set to ∞. As a result, the optical coupler CPI outputs the local oscillation light LO1 having the wavelength λ1 via the variable optical attenuator VOA1 to the coherent receiver front-end unit 110. The coherent receiver front-end unit 110 coherently detects the input optical signal SO1 having the wavelength λ1 input from the wavelength selective switch 220 by the local oscillation light LO1 having the wavelength λ1 from the optical coupler CP1.

In this state, similarly to FIG. 10, the user interface unit 300 sets the wavelength information (λ2) of the next input optical signal SO1 to the control unit 210 (S101). The control unit 210 instructs the local oscillation light source A2 to change the light output wavelength to λ2 (S102), the local oscillation light source A2 changes the wavelength of the local oscillation light LO2 to be output to the instructed wavelength λ2 (S103) and notifies the control unit 210 of the completion of the wavelength change (S104), and the control unit 210 notifies the user interface unit 300 of standby OK (S105).

Thereafter, the user interface unit 300 instructs the control unit 210 to implement wavelength change of the input optical signal SO1 (S106).

Upon receiving the instruction to implement change of the input optical signal SO1 from the user interface unit 300, the control unit 210 instructs the variable optical attenuator VOA1 to change the attenuation amount to ∞ (S121) and instructs the variable optical attenuator VOA2 to change the attenuation amount to 0 (S122). In addition, the control unit 210 instructs the wavelength selective switch 220 to change the selected wavelength to the wavelength 22 (S108).

Upon receiving the instruction to change the attenuation amount from the user interface unit 300, the variable optical attenuator VOA1 changes the attenuation amount of the local oscillation light LO1 to ∞, stops the output of the local oscillation light LO1 having the wavelength λ1 (S123), and notifies the control unit 210 of the change completion (S124). Upon receiving the instruction to change the attenuation amount from the user interface unit 300, the variable optical attenuator VOA2 changes the attenuation amount of the local oscillation light LO2 to 0, starts the output of the local oscillation light LO2 having the wavelength λ2 (S125), and notifies the control unit 210 of the change completion (S126). Furthermore, upon receiving the instruction to change the selected wavelength from the user interface unit 300, the wavelength selective switch 220 switches to select and output the wavelength λ2 (S111), and notifies the control unit 210 of the change completion (S112).

As a result, the wavelength selective switch 220 selects the optical signal having the wavelength λ2 from the wavelength multiplex signal WO, and outputs the selected optical signal having the wavelength λ2 as the input optical signal SO1. In addition, the optical coupler CP1 outputs the local oscillation light LO2 having the wavelength λ2, and the coherent receiver front-end unit 110 coherently detects the input optical signal SO1 having the wavelength λ2 input from the wavelength selective switch 220 by the local oscillation light LO2 having the wavelength λ2 from the optical coupler CP1.

Upon receiving the change completion of the attenuation amount from the variable optical attenuators VOA1 and VOA2 and receiving the change completion from the wavelength selective switch 220, the control unit 210 notifies the user interface unit 300 of the completion of the wavelength change implementation of the input optical signal SO1 (S113).

### Third Specific Example of First Example Embodiment

Next, a third specific example of the first example embodiment will be described. In the present third specific example, the local oscillation lights of the plurality of local oscillation light sources are further switched by the optical switch of the local oscillation light selection unit 131.

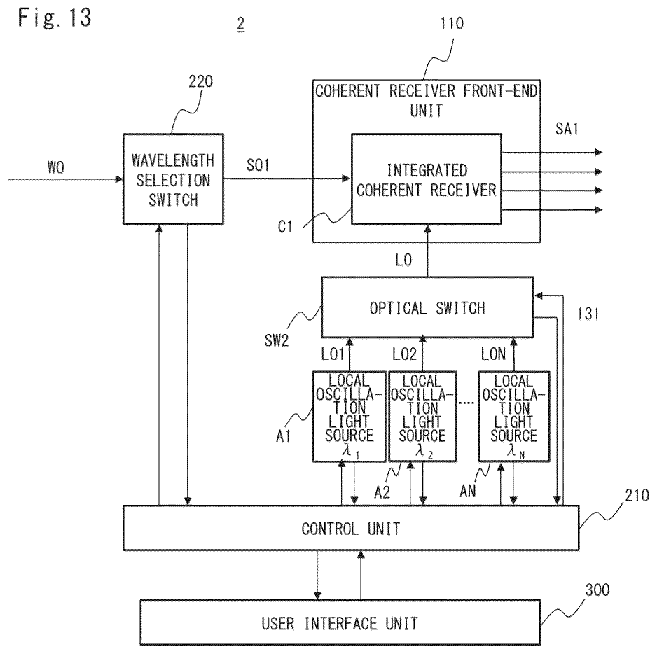

FIG. 13 illustrates a configuration example of the local oscillation light selection unit 131 according to the present third specific example. As illustrated in FIG. 13, in the present third specific example, similarly to the first specific example, the local oscillation light selection unit 131 is configured by the optical switch SW2. In addition, in the present third specific example, the optical relay apparatus 2 includes a plurality of local oscillation light sources A1 to AN. The local oscillation light sources A1 to AN output local oscillation light having different fixed wavelengths. The local oscillation light sources A1 to AN are light sources for a wavelength that can be used in the optical transmission system 1. The wavelengths of the local oscillation light sources A1 to AN are related to each wavelength used in the optical transmission system 1, and are λ1 to λN.

The optical switch SW2 is a local oscillation light selection switch and is an N×1 optical switch (N input−1 output optical switch). The optical switch SW3 selects any of the local oscillation light LO1 to LON input from the local oscillation light sources A1 to AN, and outputs the selected light to the coherent receiver front-end unit 110 as the local oscillation light LO. The optical switch SW2 switches the local oscillation light LO to be output from the input light in response to an instruction from the control unit 210. The same functions as those of the optical switch SW2 may be achieved by a variable optical attenuator and an optical coupler as in the second specific example.

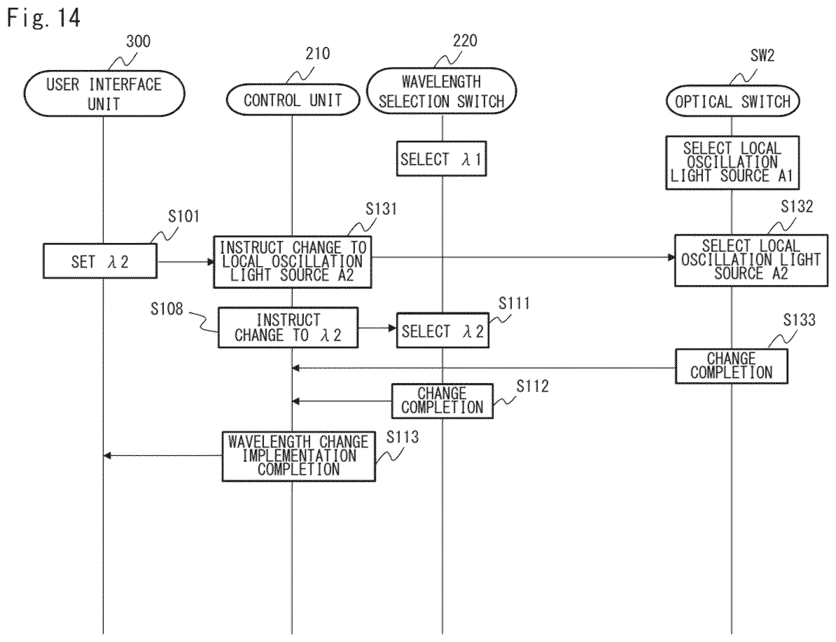

FIG. 14 illustrates an operation example of the present third specific example. Similarly to FIG. 10, FIG. 14 illustrates an operation example in a case where the wavelength of the input optical signal SO1 is switched from λ1 to λ2.

In the example of FIG. 14, first, similarly to FIG. 10, the wavelength of the input optical signal SO1 is operated at λ1. Specifically, λ1 is set as the selected wavelength of the wavelength selective switch 220, and the wavelength selective switch 220 selects the optical signal having the wavelength λ1 from the wavelength multiplex signal WO and outputs the selected optical signal having the wavelength λ1 as the input optical signal SO1.

Furthermore, the local oscillation light sources A1 to AN are set to output the local oscillation light having the wavelengths λ1 to AN, the optical switch SW2 is set to select the local oscillation light LO1 of the local oscillation light source A1, and the local oscillation light LO1 having the wavelength λ1 is output from the optical switch SW2. The coherent receiver front-end unit 110 coherently detects the input optical signal SO1 having the wavelength λ1 input from the wavelength selective switch 220 by the local oscillation light LO1 having the wavelength λ1 from the optical switch SW2.

In this state, the user interface unit 300 sets the wavelength information (λ2) of the next input optical signal SO1 to the control unit 210 (S101). For example, at the timing of switching the wavelength of the input optical signal SO1, the user inputs the next wavelength λ2 to the user interface unit 300, and the user interface unit 300 sets the wavelength information of the input wavelength λ2.

Upon receiving the wavelength information (λ2) of the next input optical signal SO1 from the user interface unit 300, the control unit 210 instructs the optical switch SW2 to change the selection of the input signal to the local oscillation light source A2 side (S131). In addition, the control unit 210 instructs the wavelength selective switch 220 to change the selected wavelength to the wavelength λ2 (S108).

Upon receiving the instruction to change the selection of the input signal from the user interface unit 300, the optical switch SW2 switches to select and output the local oscillation light LO2 of the local oscillation light source A2 (S132), and notifies the control unit 210 of the change completion (S133). Furthermore, upon receiving the instruction to change the selected wavelength from the user interface unit 300, the wavelength selective switch 220 switches to select and output the wavelength λ2 (S111), and notifies the control unit 210 of the change completion (S112).

As a result, the wavelength selective switch 220 selects the optical signal having the wavelength λ2 from the wavelength multiplex signal WO, and outputs the selected optical signal having the wavelength λ2 as the input optical signal SO1. The optical switch SW2 outputs the local oscillation light LO2 having the wavelength λ2, and the coherent receiver front-end unit 110 coherently detects the input optical signal SO1 having the wavelength λ2 input from the wavelength selective switch 220 by the local oscillation light LO2 having the wavelength λ2 from the optical switch SW2.

Upon receiving the change completion of the input signal selection from the optical switch SW2 and receiving the change completion from the wavelength selective switch 220, the control unit 210 notifies the user interface unit 300 of the completion of the wavelength change implementation of the input optical signal SO1 (S113).

As described above, in the present example embodiment, the local oscillation lights from the plurality of local oscillation light sources are selected by the selection unit such as the optical switch, and is output to the coherent receiver front-end unit. As a result, in a case where the wavelength of the input optical signal input to the optical relay apparatus is changed, the time required for wavelength change of the local oscillation light source can be shortened. Although it takes several seconds to several tens of seconds to change the output light wavelength of the wavelength variable light source used as the local oscillation light source, it is possible to respond to the rapid wavelength switching according to the present example embodiment.

For example, as in the first specific example, the wavelength switching time can be shortened to about several tens of milliseconds by switching the local oscillation light source by the optical switch. Furthermore, as in the second specific example, the wavelength switching time can be further shortened to about several milliseconds by realizing the same function as the optical switch by the variable optical attenuator and the optical coupler. In addition, as in the third specific example, the wavelength can be immediately switched without changing the wavelength of the wavelength variable light source in advance by preparing a local oscillation light source for a wavelength that can be used and switching the local oscillation light source.

### SECOND EXAMPLE EMBODIMENT

Next, a second example embodiment will be described. In the present example embodiment, an example in which any of a plurality of transmission light sources is selected and the wavelength of the transmission light is switched will be described. The present example embodiment is an example in which the configuration on the local oscillation light source side of the first example embodiment is applied to the transmission light source side. The present example embodiment can be implemented in combination with the first example embodiment, and each component described in the first example embodiment may be appropriately used.

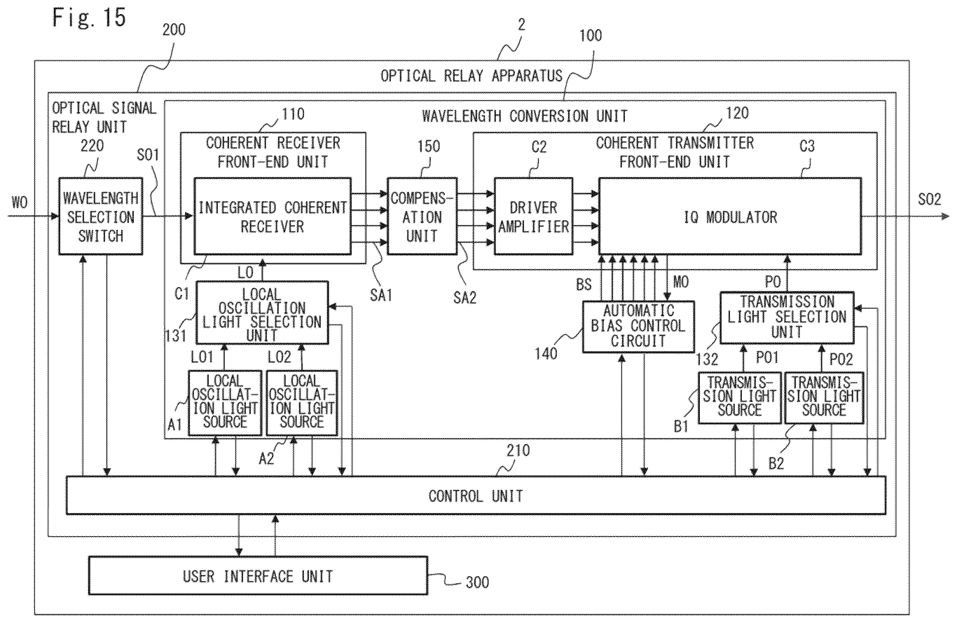

FIG. 15 illustrates a configuration example of the optical relay apparatus 2 according to the present example embodiment. As illustrated in FIG. 15, the optical relay apparatus 2 according to the present example embodiment further includes, for example, a transmission light source B2 and a transmission light selection unit 132 as compared with FIG. 6 of the first example embodiment.

In the present example embodiment, the transmission light source B1 (e. g., a third light source) generates transmission light PO1 having a third wavelength, and outputs the generated transmission light PO1 to the transmission light selection unit 132. The transmission light source B2 (e.g., a fourth light source) generates transmission light PO2 having a fourth wavelength, and outputs the generated transmission light PO2 to the transmission light selection unit 132. For example, the transmission light sources B1 and B2 are wavelength variable light sources, and generate and output transmission lights PO1 and PO2 having wavelengths set by the control unit 210. The transmission light sources B1 and B2 are not limited to wavelength variable light sources, and may generate transmission lights PO1 and PO2 having preset fixed wavelengths, respectively. For example, a plurality of wavelength fixed light sources of two or more may be provided as the transmission light source.

The transmission light selection unit 132 (e.g., a second selection unit) selects either one of the transmission lights PO1 and PO2 input from the transmission light sources B1 and B2, and outputs the selected light to the coherent transmitter front-end unit 120 as the transmission light PO. The transmission light selection unit 132 selects the transmission light of any transmission light source according to the control from the control unit 210. In a case where the transmission light sources B1 and B2 are wavelength variable light sources and are switched from the transmission light source B1 to the transmission light source B2, the transmission light selection unit 132 may select and output the transmission light PO2 of the transmission light source B2 after the wavelength switching of the transmission light source B2 is completed. For example, similarly to the local oscillation light selection unit 131, the transmission light selection unit 132 may be configured by an optical switch, may be configured by an variable optical attenuator and an optical coupler, or may have other configurations. Other configurations are similar to those in the first example embodiment.

In the example of FIG. 15, the local oscillation light selection unit 131 switches the local oscillation light of the local oscillation light source A1 or A2 upon switching the wavelength of the input optical signal SO1, and the transmission light selection unit 132 switches the transmission light of the transmission light source B1 or B2 upon switching the wavelength of the output optical signal SO2. Either wavelength of the input optical signal SO1 or the output optical signal SO2 may be switched, or both wavelengths may be switched. Upon switching both wavelengths of the input optical signal SO1 and the output optical signal SO2, the wavelength switching of the input optical signal SO1 and the wavelength switching of the output optical signal SO2 may be performed in parallel, or either of them may be performed first.

For example, in a case where the wavelength of the output optical signal SO2 is set or switched, the control unit 210 controls the operations of the transmission light sources B1 and B2 and the transmission light selection unit 132. In the control with respect to the transmission light sources B1 and B2, in a case where the transmission light sources B1 and B2 are wavelength variable light sources, the control unit 210 sets the wavelengths of the transmission lights PO1 and PO2 output from the transmission light sources B1 and B2 based on the setting information or the wavelength change instruction acquired from the user interface unit 300. In the control with respect to the transmission light selection unit 132, the control unit 210 controls the transmission light selected by the transmission light selection unit 132 based on the setting information or the wavelength change instruction acquired from the user interface unit 300.

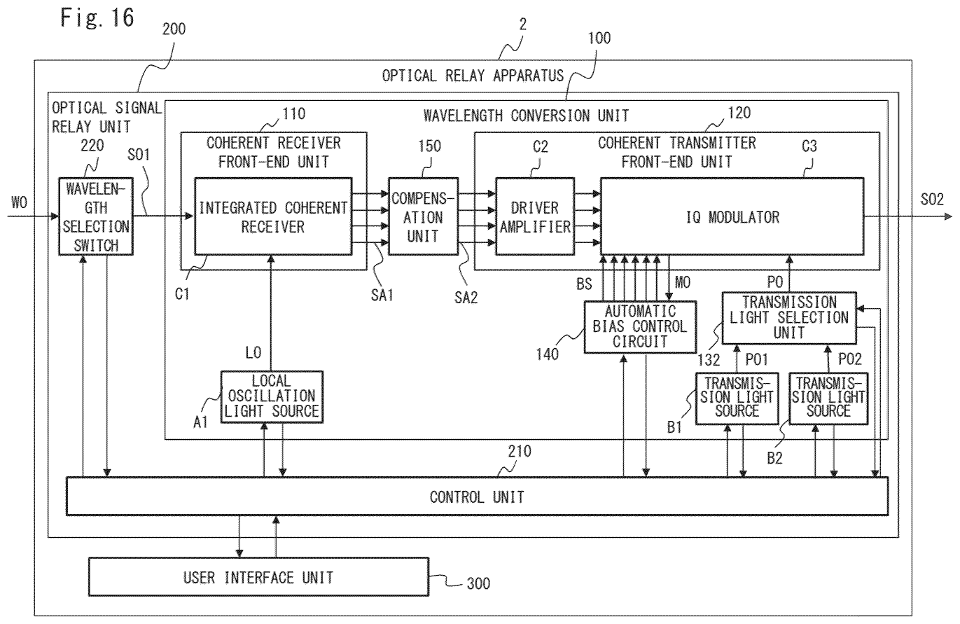

The configuration is not limited to the configuration example of FIG. 15, and as illustrated in FIG. 16, the optical relay apparatus 2 may be configured to include only one light source on the local oscillation light source side. In the example of FIG. 16, the local oscillation light source A1 generates the local oscillation light LO1 having a predetermined wavelength, and outputs the generated local oscillation light LO to the coherent receiver front-end unit 110.

In this case, the local oscillation light source A1 is a wavelength variable light source, and generates and outputs the local oscillation light LO having the wavelength set by the control unit 210.

### First Specific Example of Second Example Embodiment

Next, a first specific example of the second example embodiment will be described. In the present first specific example, an optical switch is used as the transmission light selection unit 132. The first specific example is an example in which the configuration of the first specific example of the first example embodiment is applied to the transmission light source side.

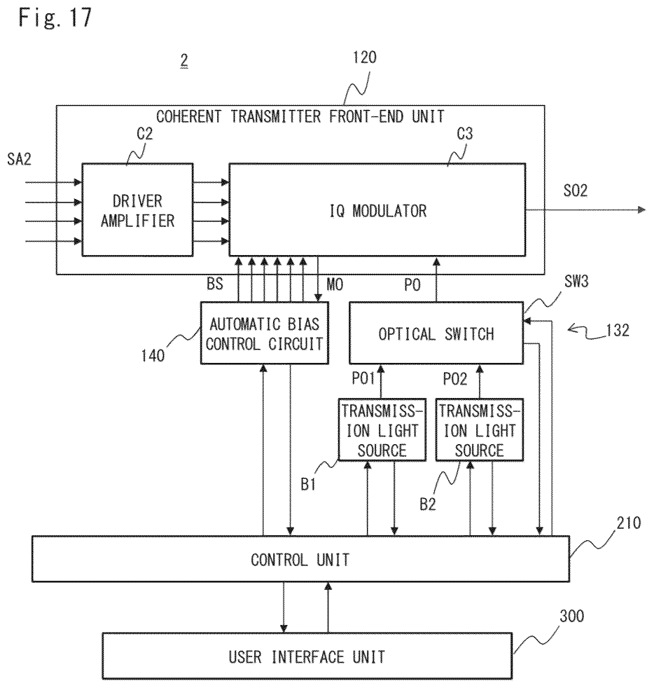

FIG. 17 illustrates a configuration example of the transmission light selection unit 132 according to the present first specific example. As illustrated in FIG. 17, in the present first specific example, the transmission light selection unit 132 includes an optical switch SW3. Furthermore, in the present first specific example, the transmission light sources B1 and B2 are wavelength variable light sources.

The optical switch SW3 is a transmission light selection switch and is a 2×1 optical switch (2 input−1 output optical switch). The optical switch SW3 selects either the transmission light PO1 or the transmission light PO2 input from the transmission light sources B1 and B2, and outputs the selected light to the coherent transmitter front-end unit 120 as the transmission light PO. The optical switch SW3 switches the transmission light PO to be output from the input light in response to an instruction from the control unit 210.

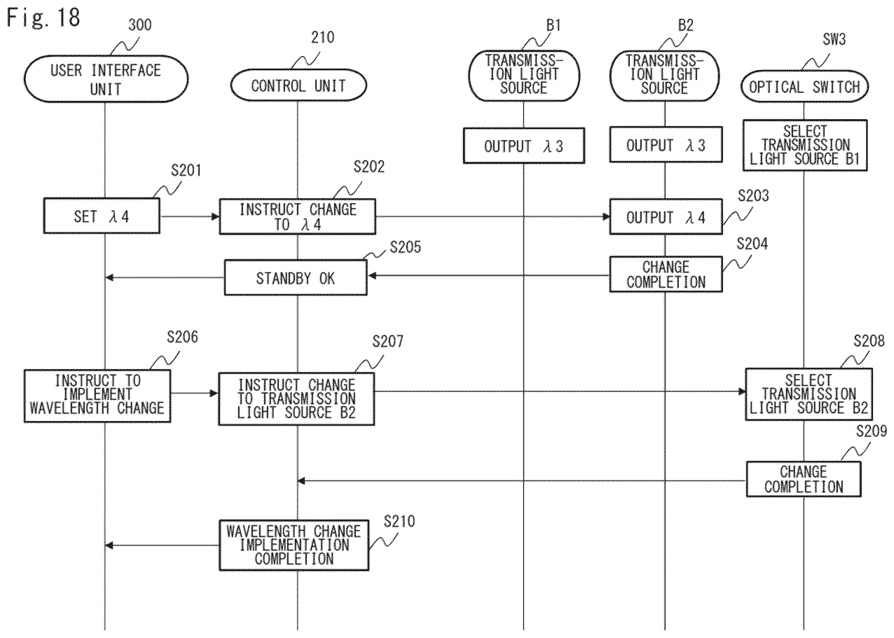

FIG. 18 illustrates an operation example of the present first specific example. FIG. 18 illustrates an operation example in a case where the wavelength of the output optical signal SO2 is switched from λ3 to λ4. FIG. 18 is an example, and in a case where the transmission light source B1 outputs the transmission light PO1 having the wavelength λ3 and the transmission light source B2 outputs the transmission light source PO2 having the wavelength λ4, S202 to S206 may be omitted. In this case, the user interface unit 300 may set the wavelength information (λ4) of the next output optical signal SO2 to the control unit 210 (S201), and the control unit 210 may instruct the optical switch SW3 to change the selection of the input signal to the transmission light source B2 side (S207).

In the example of FIG. 18, first, the wavelength of the output optical signal SO2 is operated at λ3. Specifically, the wavelengths of the transmission light sources B1 and B2 are set to λ3, and the transmission light POI having the wavelength λ3 and the transmission light PO2 having the wavelength λ3 are output from the transmission light sources B1 and B2. The optical switch SW3 is set to select the transmission light POI on the transmission light source B1 side, and the transmission light PO1 having the wavelength λ3 is output from the optical switch SW3. The coherent transmitter front-end unit 120 coherently modulates the analog electric signal SA2 input from the compensation unit 150 by the transmission light POI having the wavelength λ3 from the optical switch SW3.

In this state, the user interface unit 300 sets the wavelength information (λ4) of the next output optical signal SO2 to the control unit 210 (S201). For example, before switching the wavelength of the output optical signal SO2, the user inputs the next wavelength λ4 to the user interface unit 300, and the user interface unit 300 sets the wavelength information of the input wavelength λ4.

Upon receiving the wavelength information (λ4) of the next output optical signal SO2 from the user interface unit 300, the control unit 210 instructs the transmission light source B2 (transmission light source that is not currently selected by the optical switch) to change the light output wavelength to λ4 (S202). Upon receiving the instruction to change the wavelength to λ4 from the control unit 210, the transmission light source B2 changes the wavelength of the transmission light PO2 to be output to the instructed wavelength λ4 (S203), and notifies the control unit 210 of the completion of the wavelength change (S204).

Upon receiving the completion of the wavelength change from the transmission light source B2, the control unit 210 notifies the user interface unit 300 of standby OK (S205). For example, the user interface unit 300 receives the standby OK from the control unit 210, and outputs (displays) to the user that the standby of the wavelength switching of the output optical signal SO2 is completed.

Thereafter, the user interface unit 300 instructs the control unit 210 to implement wavelength change of the output optical signal SO2 (S206). For example, after receiving the standby OK, the user inputs a wavelength change implementation instruction to the user interface unit 300 at any timing (timing to switch the wavelength of the output optical signal SO2), and the user interface unit 300 instructs the implementation of wavelength change.

Upon receiving the instruction to implement wavelength change of the output optical signal SO2 from the user interface unit 300, the control unit 210 instructs the optical switch SW3 to change the selection of the input signal to the transmission light source B2 side (S207).

Upon receiving the instruction to change the selection of the input signal from the control unit 210, the optical switch SW3 switches to select and output the transmission light PO2 of the transmission light source B2 (S208), and notifies the control unit 210 of the change completion (S209).

As a result, the optical switch SW3 outputs the transmission light PO2 having the wavelength λ4, and the coherent transmitter front-end unit 120 coherently modulates the analog electric signal SA2 input from the compensation unit 150 by the transmission light PO2 having the wavelength λ4 from the optical switch SW3.

Upon receiving the change completion of the input signal selection from the optical switch SW3, the control unit 210 notifies the user interface unit 300 of the completion of the wavelength change implementation of the output optical signal SO2 (S210). For example, the user interface unit 300 receives the notification of the completion of the wavelength change implementation from the control unit 210, and outputs (displays) to the user that the wavelength change implementation of the output optical signal SO2 is completed.

### Second Specific Example of Second Example Embodiment

Next, a second specific example of the second example embodiment will be described. In the present second specific example, an variable optical attenuator and an optical coupler are used as the transmission light selection unit 132. The second specific example is an example in which the configuration of the second specific example of the first example embodiment is applied to the transmission light source side.

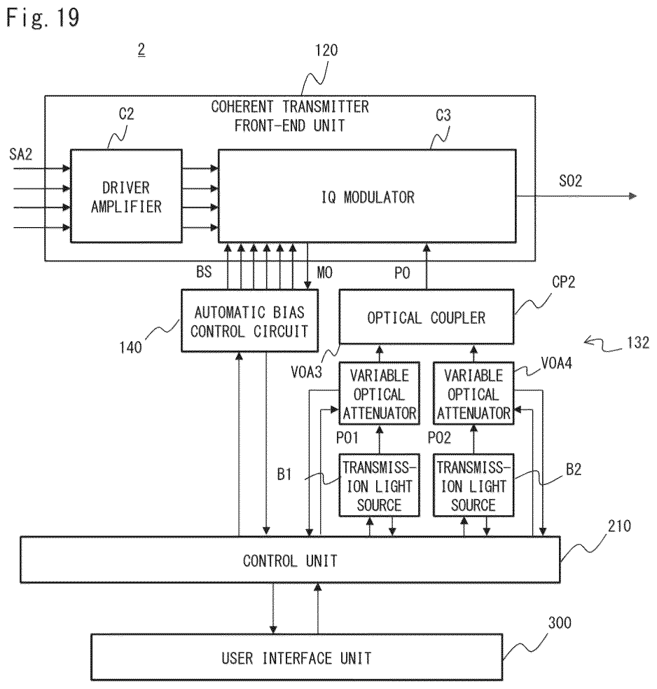

FIG. 19 illustrates a configuration example of the transmission light selection unit 132 according to the present second specific example. As illustrated in FIG. 19, in the present second specific example, the transmission light selection unit 132 includes variable optical attenuators VOA3 and VOA4 and an optical coupler CP2. Furthermore, in the present first specific example, the transmission light sources B1 and B2 are wavelength variable light sources.

The variable optical attenuator VOA3 attenuates the optical power of the transmission light PO1 input from the transmission light source B1, and outputs the attenuated optical signal to the optical coupler CP2. The variable optical attenuator VOA3 attenuates the optical power of the transmission light POI by the attenuation amount set from the control unit 210. For example, if the attenuation amount is ∞ (infinity), the transmission light PO1 is not output from the variable optical attenuator VOA3.

Similarly to the variable optical attenuator VOA3, the variable optical attenuator VOA4 attenuates the optical power of the transmission light PO2 input from the transmission light source B2, and outputs the attenuated optical signal to the optical coupler CP2. The variable optical attenuator VOA4 attenuates the optical power of the transmission light PO2 by the attenuation amount set from the control unit 210. For example, if the attenuation amount is co, the variable optical attenuator VOA4, the transmission light PO2 is not output.

The optical coupler (multiplexer) CP2 is a 1×2 optical coupler (1 input−2 output optical coupler), and multiplexes the transmission light PO1 and the transmission light PO2 input via the variable optical attenuators VOA3 and VOA4, and outputs the multiplexed light to the coherent transmitter front-end unit 120 as the transmission light PO. Either the transmission light PO1 or the transmission light PO2 is output from the optical coupler CP2 by controlling the attenuation amounts of the variable optical attenuators VOA3 and VOA4. For example, in a case where the transmission light PO2 is not output from the variable optical attenuator VOA4 while the transmission light POI is being output from the variable optical attenuator VOA3, the optical coupler CP2 outputs the transmission light PO1. In a case where the transmission light PO1 is not output from the variable optical attenuator VOA3 while the transmission light PO2 is being output from the variable optical attenuator VOA4, the optical coupler CP2 outputs the transmission light PO2.

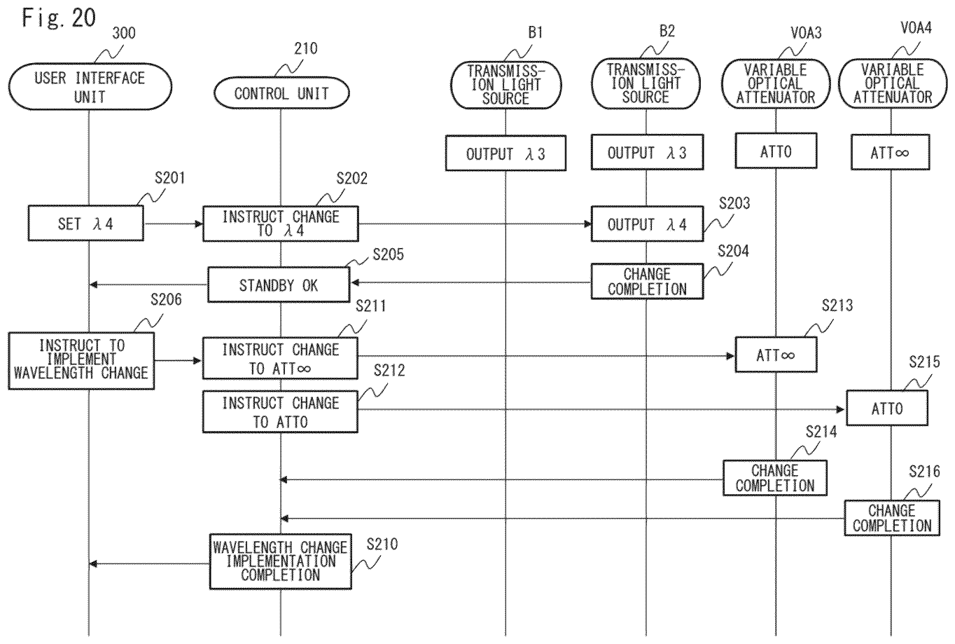

FIG. 20 illustrates an operation example of the present second specific example. Similarly to FIG. 18, FIG. 20 illustrates an operation example in a case where the wavelength of the output optical signal SO2 is switched from λ3 to λ4. FIG. 20 is an example, and in a case where the transmission light source B1 outputs the transmission light POI having the wavelength λ3 and the transmission light source B2 outputs the transmission light source PO2 having the wavelength λ4, S202 to S206 may be omitted. In this case, the user interface unit 300 may set the wavelength information (λ4) of the next output optical signal SO2 to the control unit 210 (S201), and the control unit 210 may instruct the variable optical attenuator VOA3 to change the attenuation amount to ∞ (S211) and instruct the variable optical attenuator VOA4 to change the attenuation amount to 0 (S212).

In the example of FIG. 20, first, similarly to FIG. 18, the wavelength of the output optical signal SO2 is operated at λ3. Specifically, the wavelengths of the transmission light sources B1 and B2 are set to λ3, and the transmission light PO1 having the wavelength λ3 and the transmission light PO2 having the wavelength 23 are output from the transmission light sources B1 and B2. The attenuation amount (ATT) of the variable optical attenuator VOA3 is set to 0, and the attenuation amount of the variable optical attenuator VOA4 is set to ∞. As a result, the optical coupler CP2 outputs the transmission light POI having the wavelength λ3 via the variable optical attenuator VOA3 to the coherent transmitter front-end unit 120. The coherent transmitter front-end unit 120 coherently modulates the analog electric signal SA2 input from the compensation unit 150 by the transmission light POI having the wavelength λ3 from the optical coupler CP2.

In this state, similarly to FIG. 18, the user interface unit 300 sets the wavelength information (λ4) of the next output optical signal SO2 to the control unit 210 (S201). The control unit 210 instructs the transmission light source B2 to change the light output wavelength to λ4 (S202), the transmission light source B2 changes the wavelength of the transmission light PO2 to be output to the instructed wavelength λ4 (S203) and notifies the control unit 210 of the completion of the wavelength change (S204), and the control unit 210 notifies the user interface unit 300 of standby OK (S205).

Thereafter, the user interface unit 300 instructs the control unit 210 to implement wavelength change of the output optical signal SO2 (S206).

Upon receiving the instruction to implement wavelength change of the output optical signal SO2 from the user interface unit 300, the control unit 210 instructs the variable optical attenuator VOA3 to change the attenuation amount to ∞ (S211) and instructs the variable optical attenuator VOA4 to change the attenuation amount to 0 (S212).

Upon receiving the instruction to change the attenuation amount from the user interface unit 300, the variable optical attenuator VOA3 changes the attenuation amount of the transmission light PO1 to ∞, stops the output of the transmission light PO1 having the wavelength λ3 (S213), and notifies the control unit 210 of the change completion (S214). Upon receiving the instruction to change the attenuation amount from the user interface unit 300, the variable optical attenuator VOA4 changes the attenuation amount of the transmission light PO2 to 0, starts the output of the transmission light PO2 having the wavelength λ4 (S215), and notifies the control unit 210 of the change completion (S216).

As a result, the optical coupler CP2 outputs the transmission light PO2 having the wavelength λ4, and the coherent transmitter front-end unit 120 coherently modulates the analog electric signal SA2 input from the compensation unit 150 by the transmission light PO2 having the wavelength λ4 from the optical coupler CP2.

Upon receiving the change completion of the attenuation amount from the variable optical attenuators VOA3 and VOA4, the control unit 210 notifies the user interface unit 300 of the completion of the wavelength change implementation of the output optical signal SO2 (S210).

### Third Specific Example of Second Example Embodiment

Next, a third specific example of the second example embodiment will be described. In the present third specific example, the transmission lights of the plurality of transmission light sources are further switched by the optical switch of the transmission light selection unit 132. The present third specific example is an example in which the configuration of the third specific example of the first example embodiment is applied to the transmission light source side.

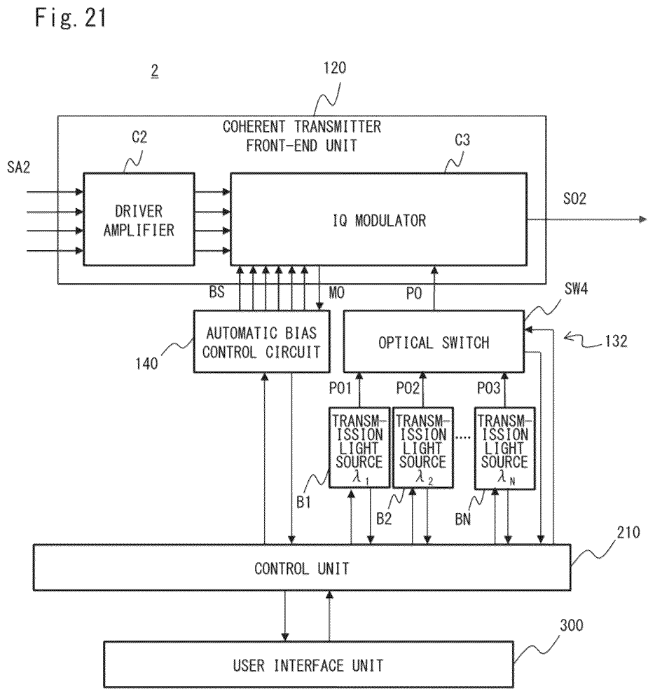

FIG. 21 illustrates a configuration example of the transmission light selection unit 132 according to the present third specific example. As illustrated in FIG. 21, in the present third specific example, similarly to the first specific example, the transmission light selection unit 132 is configured by the optical switch SW4. Furthermore, in the third specific example, the optical relay apparatus 2 includes a plurality of transmission light sources B1 to BN. The transmission light sources B1 to BN output transmission lights having different fixed wavelengths. The transmission light sources B1 to BN are light sources for a wavelength that can be used in the optical transmission system 1. The wavelengths of the transmission light sources B1 to BN are related to each wavelength used in the optical transmission system 1, and are λ1 to λN.

The optical switch SW4 is a transmission light selection switch, and is an N×1 optical switch (N input−1 output optical switch). The optical switch SW4 selects any of the transmission lights PO1 to PON input from the transmission light sources B1 to BN, and outputs the selected light to the coherent transmitter front-end unit 120 as the transmission light PO. The optical switch SW4 switches the transmission light PO to be output from the input light in response to an instruction from the control unit 210. The same functions as those of the optical switch SW4 may be achieved by an variable optical attenuator and an optical coupler as in the second specific example.

In a case where the optical relay apparatus 2 includes the local oscillation light sources A1 to AN and the transmission light sources B1 to BN, the local oscillation light source and the transmission light source may be shared. For example, N light sources for outputting optical signals having the wavelengths λ1 to AN may be provided, and the optical signals having the wavelengths λ1 to AN may be output from the N light sources to the optical switch SW2 on the local oscillation light source side and the optical switch SW4 on the transmission light source side to switch between the local oscillation light and the transmission light. In this case, the N light sources output optical signals having power necessary for the local oscillation light and the transmission light.

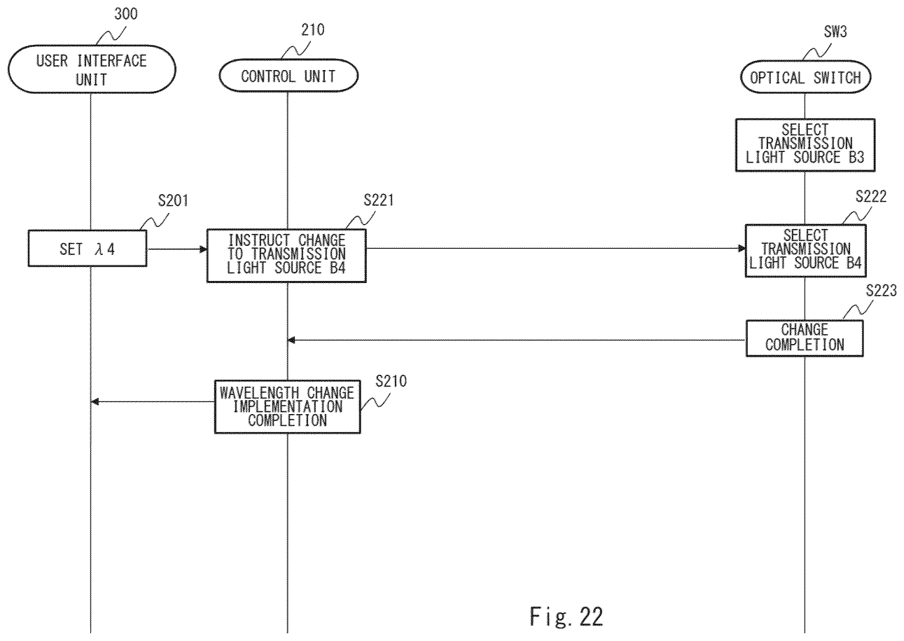

FIG. 22 illustrates an operation example of the present third specific example. Similarly to FIG. 18, FIG. 22 illustrates an operation example in a case where the wavelength of the output optical signal SO2 is switched from λ3 to λ4.

In the example of FIG. 22, first, similarly to FIG. 18, the wavelength of the output optical signal SO2 is operated at 23. Specifically, the transmission light sources B1 to BN output the transmission lights having the wavelengths λ1 to AN, the optical switch SW4 is set to select the transmission light PO3 of the transmission light source B3, and the transmission light PO3 having the wavelength 23 is output from the optical switch SW4. The coherent transmitter front-end unit 120 coherently modulates the analog electric signal SA2 input from the compensation unit 150 by the transmission light PO3 having the wavelength λ3 from the optical switch SW4.

In this state, the user interface unit 300 sets the wavelength information (λ4) of the next output optical signal SO2 to the control unit 210 (S201). For example, at the timing of switching the wavelength of the output optical signal SO2, the user inputs the next wavelength λ4 to the user interface unit 300, and the user interface unit 300 sets the wavelength information of the input wavelength λ4.

Upon receiving the wavelength information (λ4) of the next output optical signal SO2 from the user interface unit 300, the control unit 210 instructs the optical switch SW4 to change the selection of the input signal to the transmission light source B4 side (S221).

Upon receiving the instruction to change the selection of the input signal from the user interface unit 300, the optical switch SW4 switches to select and output the transmission light PO4 of the transmission light source B4 (S222), and notifies the control unit 210 of the change completion (S223).

As a result, the optical switch SW4 outputs the transmission light PO4 having the wavelength λ4, and the coherent transmitter front-end unit 120 coherently modulates the analog electric signal SA2 input from the compensation unit 150 by the transmission light PO4 having the wavelength λ4 from the optical switch SW4.

Upon receiving the change completion of the input signal selection from the optical switch SW3, the control unit 210 notifies the user interface unit 300 of the completion of the wavelength change implementation of the output optical signal SO2 (S210).

As described above, in the present example embodiment, the transmission lights from the plurality of transmission light sources are selected by the selection unit such as the optical switch and output to the coherent transmitter front-end unit. As a result, similarly to the first example embodiment, in the event that the wavelength of the output optical signal output from the optical relay apparatus is changed, the time required for wavelength change of the transmission light source can be shortened. Although it takes several seconds to several tens of seconds to change the output light wavelength of the wavelength variable light source used as the transmission light source, it is possible to respond to the rapid wavelength switching according to the present example embodiment. For the first to third specific examples as well, similarly to the first to third specific examples of the first example embodiment, the wavelength switching time can be shortened.

### Third Example Embodiment

Next, a third example embodiment will be described. In the present example embodiment, an example in which the automatic bias control circuit resumes the automatic bias control after the wavelength switching using the bias voltage immediately before the wavelength switching will be described. The present example embodiment can be implemented in combination with the first or second example embodiment, and each configuration described in the first or second example embodiment may be appropriately used.

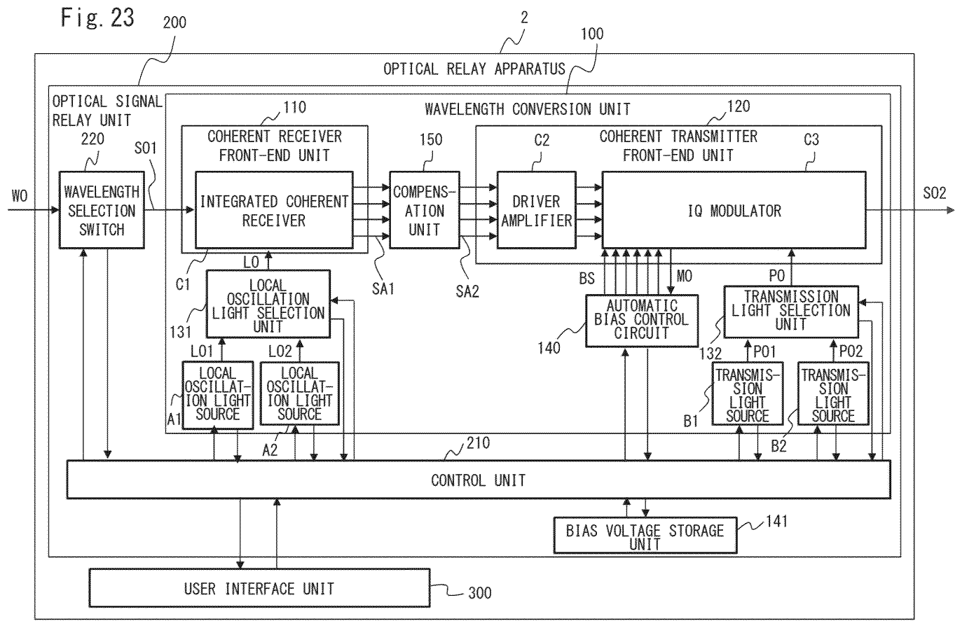

FIG. 23 illustrates a configuration example of the optical relay apparatus 2 according to the present example embodiment. As illustrated in FIG. 23, the optical relay apparatus 2 according to the present example embodiment further includes, for example, a bias voltage storage unit 141 as compared with FIG. 15 of the second example embodiment.

In the present example embodiment, the automatic bias control circuit 140 suspends (interrupts) and resumes (starts) the automatic bias control processing according to the control from the control unit 210. In addition, during a temporary stopping of the automatic bias control processing, the automatic bias control circuit 140 notifies the control unit 210 of the bias voltage BS (optimum value of the current bias voltage) set in the IQ modulator C3 of the coherent transmitter front-end unit 120 at that time.

In addition, the control unit 210 controls the operation of the automatic bias control circuit 140 at the time of wavelength switching of the input optical signal SO1 or the output optical signal SO2. Before wavelength switching, the control unit 210 instructs the automatic bias control circuit 140 to temporarily stop the automatic bias control processing, and acquires the bias voltage BS at the time of the temporary stopping. The bias voltage storage unit 141 stores the bias voltage BS acquired from the automatic bias control circuit 140. After the wavelength switching is completed, the control unit 210 instructs the automatic bias control circuit 140 to resume the automatic bias control processing. In resuming the automatic bias control processing, the control unit 210 resumes the automatic bias control processing by the bias voltage BS stored in the bias voltage storage unit 141. Other configurations are similar to those in the first and second example embodiments.

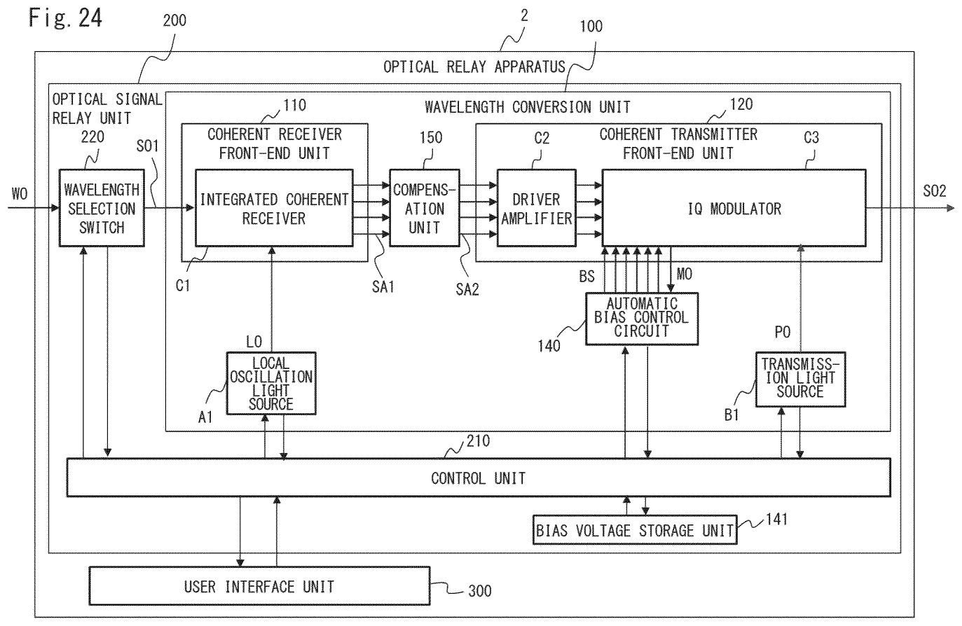

The configuration is not limited to the configuration example of FIG. 23, and the optical relay apparatus 2 may be configured to include only one light source on either or both of the local oscillation light source side and the transmission light source side. For example, in the example of FIG. 24, only one light source is provided on each of the local oscillation light source side and the transmission light source side. In the example of FIG. 24, the local oscillation light source A1 generates the local oscillation light LO1 having a predetermined wavelength, and outputs the generated local oscillation light LO to the coherent receiver front-end unit 110. In this case, the local oscillation light source A1 is a wavelength variable light source, and generates and outputs the local oscillation light LO having the wavelength set by the control unit 210. Furthermore, the transmission light source B1 generates transmission light PO1 having a predetermined wavelength, and outputs the generated transmission light PO to the coherent transmitter front-end unit 120. In this case, the transmission light source B1 is a wavelength variable light source, and generates and outputs transmission light PO having a wavelength set by the control unit 210.

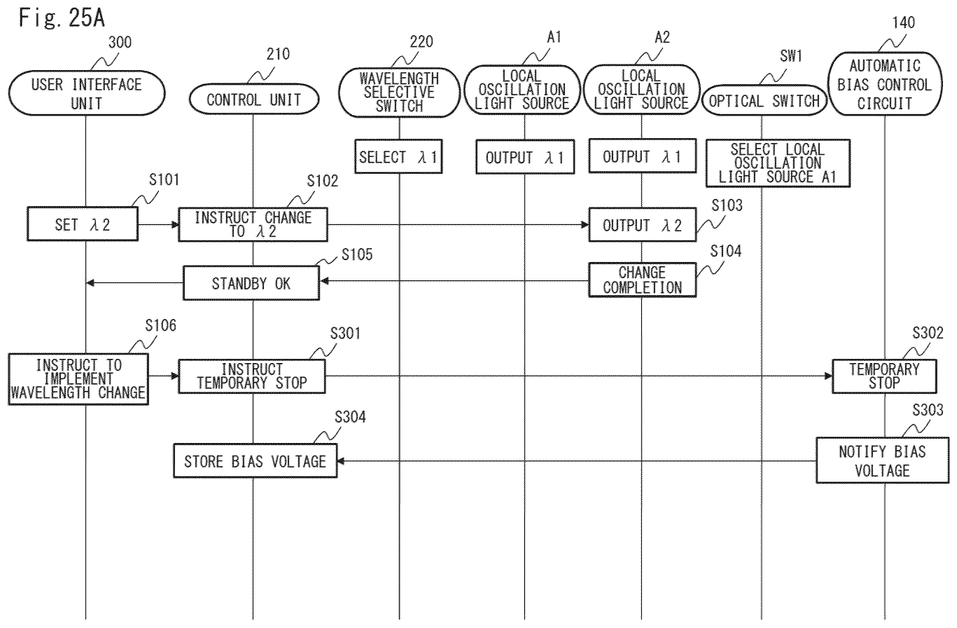

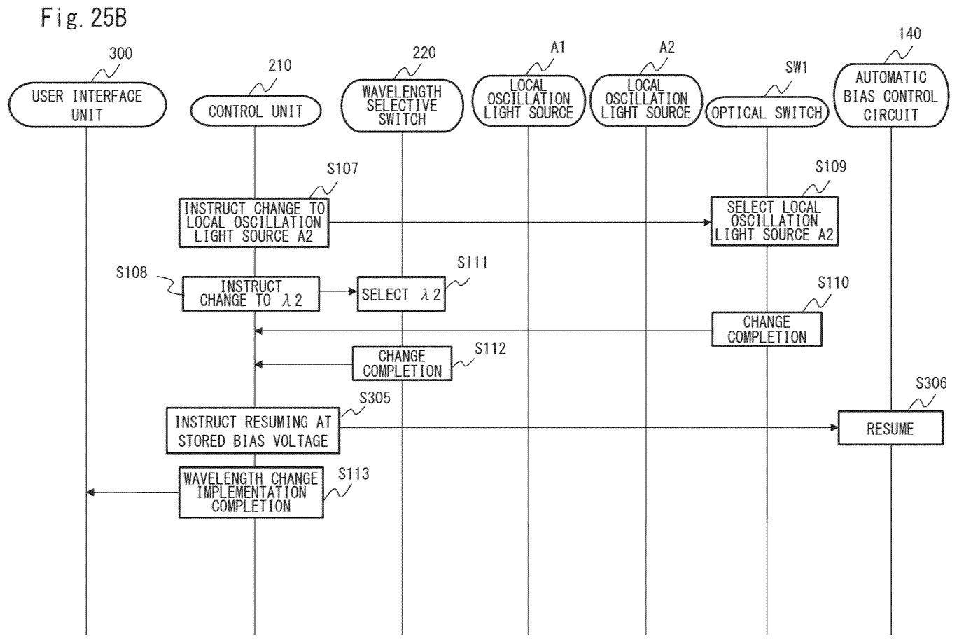

FIGS. 25A and 25B illustrate an example of the operation of the present example embodiment. FIGS. 25A and 25B are examples in which the present example embodiment is applied to the operation of the first specific example of the first example embodiment in FIG. 10. In this example, as in the first specific example of the first example embodiment, the local oscillation light selection unit 131 is configured by the optical switch SW1. The present example embodiment may be applied to the second specific example and the third specific example of the first example embodiment. For example, in a case where the present example embodiment is applied to the operation of the second specific example of the first example embodiment in FIG. 12, according to the instruction of wavelength change implementation of the input optical signal SO1 from the user interface unit 300 (S106), S301 to S304 may be executed, the attenuation amounts of the variable optical attenuators VOA1 and VOA2 may be changed (S121 to S126), and after the wavelength selective switch 220 is switched (S108, S111 to S112), S305 to S306 may be executed. In a case where the present example embodiment is applied to the operation of the third specific example of the first example embodiment in FIG. 14, according to the setting of the wavelength information (22) of the next input optical signal SO1 from the user interface unit 300 (S101), S301 to S304 may be executed, the optical switch SW2 may be switched (S131 to S133), and after the wavelength selective switch 220 is switched (S108, S111 to S112), S305 to S306 may be executed.

Similarly to FIG. 10, FIGS. 25A and 25B are operation examples in a case where the wavelength of the input optical signal SO1 is switched from λ1 to λ2. In the examples of FIGS. 25A and 25B, first, the wavelength of the input optical signal SO1 is operated at λ1. As in FIGS. 10, λ1 is set as the selected wavelength of the wavelength selective switch 220, the wavelengths of the local oscillation light sources A1 and A2 are set to λ1, and the optical switch SWI is set to select the local oscillation light LO1 on the local oscillation light source A1 side.

In this state, similarly to FIG. 10, the user interface unit 300 sets the wavelength information (λ2) of the next input optical signal SO1 to the control unit 210 (S101). The control unit 210 instructs the local oscillation light source A2 to change the light output wavelength to λ2 (S102), the local oscillation light source A2 changes the wavelength of the local oscillation light LO2 to be output to the instructed wavelength λ2 (S103) and notifies the control unit 210 of the completion of the wavelength change (S104), and the control unit 210 notifies the user interface unit 300 of standby OK (S105).

Thereafter, the user interface unit 300 instructs the control unit 210 to implement wavelength change of the input optical signal SO1 (S106).

Upon receiving the instruction to implement wavelength change of the input optical signal SO1 from the user interface unit 300, the control unit 210 instructs the automatic bias control circuit 140 to temporarily stop the automatic bias control processing (fix the output bias voltage) (S301). Upon receiving an instruction to temporarily stop from the control unit 210, the automatic bias control circuit 140 temporarily stops the automatic bias control processing (S302), and transmits the bias voltage BS at that time to the control unit 210 (S303). Upon receiving the bias voltage BS from the automatic bias control circuit 140, the control unit 210 stores the voltage value in the bias voltage storage unit 141 (S304).

Subsequently, the control unit 210 instructs the optical switch SWI to change the selection of the input signal to the local oscillation light source A2 side (S107), and instructs the wavelength selective switch 220 to change the selected wavelength to the wavelength λ2 (S108). The optical switch SW1 switches to select and output the local oscillation light LO2 of the local oscillation light source A2 (S109) and notifies the control unit 210 of the change completion (S110), and the wavelength selective switch 220 switches to select and output the wavelength λ2 (S111) and notifies the control unit 210 of the change completion (S112).

Upon receiving the change completion of the input signal selection from the optical switch SW1 and receiving the change completion from the wavelength selective switch 220, the control unit 210 instructs the automatic bias control circuit 140 to resume the automatic bias control processing at the bias voltage BS stored in the bias voltage storage unit 141 (S305). The automatic bias control circuit 140 resumes the automatic bias control processing at the instructed bias voltage BS (S306). Subsequently, the control unit 210 notifies the user interface unit 300 of the completion of the wavelength change implementation of the input optical signal SO1 (S113).

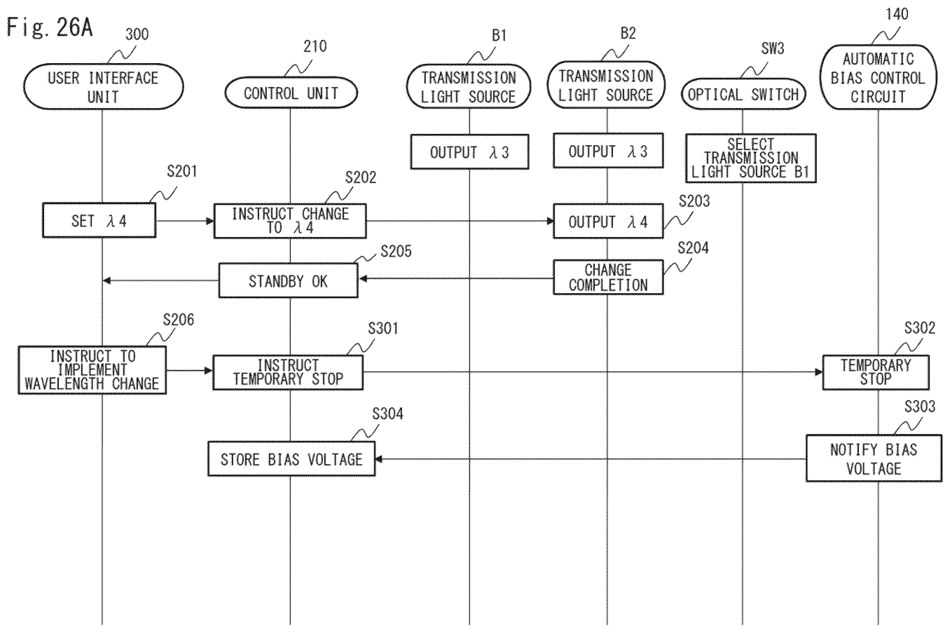

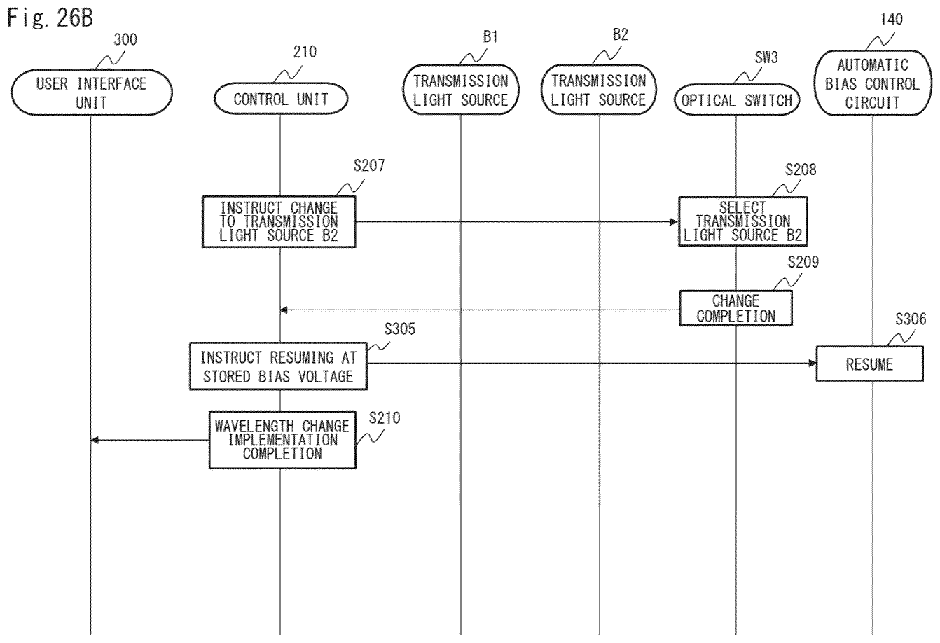

FIGS. 26A and 26B illustrate another example of the operation of the present example embodiment. FIGS. 26A and 26B are examples in which the present example embodiment is applied to the operation of the first specific example of the second example embodiment in FIG. 18. In this example, as in the first specific example of the second example embodiment, the transmission light selection unit 132 is configured by the optical switch SW3. The present example embodiment may be applied to the second specific example and the third specific example of the second example embodiment. For example, in a case where the present example embodiment is applied to the operation of the second specific example of the second example embodiment in FIG. 20, according to the instruction of wavelength change implementation of the output optical signal SO2 from the user interface unit 300 (S206), S301 to S304 may be executed, and after the attenuation amounts of the variable optical attenuators VOA3 and VOA4 are changed (S211 to S216), S305 to S306 may be executed. In the case where the present example embodiment is applied to the operation of the third specific example of the second example embodiment in FIG. 22, according to the setting of the wavelength information (λ4) of the next output optical signal SO2 from the user interface unit 300 (S201), S301 to S304 may be executed and after the optical switch SW3 is switched (S221 to S223), S305 to S306 may be executed.

Similarly to FIG. 18, FIGS. 26A and 26B are operation examples in a case where the wavelength of the output optical signal SO2 is switched from λ3 to λ4. In the examples of FIGS. 26A and 26B, first, the wavelength of the output optical signal SO2 is operated at λ3. Similarly to FIG. 18, the wavelengths of the transmission light sources B1 and B2 are set to λ3, and the optical switch SW3 is set to select the transmission light PO1 on the transmission light source B1 side.

In this state, similarly to FIG. 18, the user interface unit 300 sets the wavelength information (λ4) of the next output optical signal SO2 to the control unit 210 (S201). The control unit 210 instructs the transmission light source B2 to change the light output wavelength to λ4 (S202), the transmission light source B2 changes the wavelength of the transmission light PO2 to be output to the instructed wavelength λ4 (S203) and notifies the control unit 210 of the completion of the wavelength change (S204), and the control unit 210 notifies the user interface unit 300 of standby OK (S205).

Thereafter, the user interface unit 300 instructs the control unit 210 to implement wavelength change of the output optical signal SO2 (S206).

Upon receiving the instruction to implement wavelength change of the output optical signal SO2 from the user interface unit 300, the control unit 210 instructs the automatic bias control circuit 140 to temporarily stop the automatic bias control processing (S301). Upon receiving an instruction to temporarily stop from the control unit 210, the automatic bias control circuit 140 temporarily stops the automatic bias control processing (S302), and transmits the bias voltage BS at that time to the control unit 210 (S303). Upon receiving the bias voltage BS from the automatic bias control circuit 140, the control unit 210 stores the voltage value in the bias voltage storage unit 141 (S304).

Subsequently, the control unit 210 instructs the optical switch SW3 to change the selection of the input signal to the transmission light source B2 side (S207). The optical switch SW3 switches to select and output the transmission light PO2 of the transmission light source B2 (S208), and notifies the control unit 210 of change completion (S209).

Upon receiving the change completion of the input signal selection from £ the optical switch SW3, the control unit 210 instructs the automatic bias control circuit 140 to resume the control processing at the bias voltage BS stored in the bias voltage storage unit 141 (S305). The automatic bias control circuit 140 resumes the automatic bias control processing at the instructed bias voltage BS (S306). Subsequently, the control unit 210 notifies the user interface unit 300 of the completion of the wavelength change implementation of the output optical signal SO2 (S210).

As described above, in the present example embodiment, the automatic bias control processing of the automatic bias control circuit is temporarily stopped at the time of wavelength switching of the input optical signal to be input to the optical relay apparatus or the output optical signal to be output from the optical relay apparatus, the bias voltage at that time is stored, and the automatic bias control processing is resumed at the stored bias voltage after the wavelength switching is completed. As a result, the time until the bias voltage optimization of the modulator of the coherent transmitter front-end unit in a case where the wavelength of the input optical signal or the output optical signal is changed can be shortened.

In the event that the wavelength to be input to the modulator of the coherent transmitter front-end unit is changed, if the optical power temporarily fluctuates, the optical input disappears, or the modulation signal becomes no signal, the bias voltage controlled by the automatic bias control circuit deviates from the optimum value, and it takes time to return again, but according to the present example embodiment, the time to return to the optimum value of the bias voltage can be shortened by resuming the automatic bias control processing after the wavelength switching using the bias voltage immediately before the wavelength switching. Since the optimum bias voltage value tends to fluctuate with time, it is possible to return to the optimum bias value in a short time by using the bias voltage immediately before the wavelength switching.

The present disclosure is not limited to the above-described example embodiments, and can be appropriately modified without departing from the scope. For example, in the above example embodiment, an example in which a single wavelength (single channel) is input and one wavelength is converted into another wavelength has been described, but a plurality of wavelengths may be input and a plurality of wavelengths may be collectively converted into another plurality of wavelengths.

Each configuration in the above-described example embodiments may be configured by hardware, software, or both, may be configured by one hardware or software, or may be configured by a plurality of hardware or software. For example, the functions (processing) of the control unit 210, the user interface unit 300, and the like may be achieved by a computer including a processor such as a central processing unit (CPU) and a memory that is a storage device. For example, a program for performing the method (optical relay method) according to the example embodiment may be stored in the memory, and each function may be achieved by the processor executing the program stored in the memory.

These programs include a group of commands (or software codes) causing a computer to perform one or more of the functions described in the example embodiments in a case of being read by the computer. The program may be stored in a non-transitory computer-readable medium or a tangible storage medium. As an example and not by way of limitation, the computer-readable medium or the tangible storage medium includes a random access memory (RAM), a read only memory (ROM), a flash memory, a solid-state drive (SSD) or any other memory technology, a CD-ROM, a digital versatile disc (DVD), a Blu-ray (registered trademark) disc or any other optical disk storage, and a magnetic cassette, a magnetic tape, a magnetic disk storage, or any other magnetic storage device. The program may be transmitted through a transitory computer-readable medium or a communication medium. As an example and not by way of limitation, the transitory computer readable medium or the communication medium includes electrical, optical, acoustic, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims.

Some or all of the example embodiments described above may be described as, but are not limited to, the following Supplementary Notes.

### Supplementary Note 1

An optical relay apparatus including:
a coherent optical receiver front-end means for coherently detecting an input optical signal to be input based on a local oscillation light;
a coherent optical transmitter front-end means for coherently modulating the coherently detected signal based on a transmission light and outputting the coherently modulated output optical signal;
a first light source for outputting first light having a first wavelength; a second light source for outputting second light having a second wavelength; and
a selection means for selecting either one of the first light and the second light and outputting the selected light as the local oscillation light or the transmission light.

### Supplementary Note 2

The optical relay apparatus according to supplementary note 1, in which the selection means includes an optical switch configured to receive the first light and the second light and switch light to be output from the received light.

### Supplementary Note 3

The optical relay apparatus according to supplementary note 1,
in which the selection means includes:
a first variable attenuator for attenuating power of the first light with a set attenuation amount;
a second variable attenuator for attenuating power of the second light with a set attenuation amount; and
an optical coupler configured to multiplex the first light via the first variable attenuator and the second light via the second variable attenuator.

### Supplementary Note 4

The optical relay apparatus according to supplementary note 3, in which either one of the first light and the second light is output from the optical coupler by controlling the attenuation amount of the first variable attenuator and the attenuation amount of the second variable attenuator.

### Supplementary Note 5

The optical relay apparatus according to any one of supplementary notes 1 to 4, in which
the first light source and the second light source are wavelength variable light sources, and
in a case where light to be selected is switched from the first light to the second light, the selection means switches the light to be selected to the second light after wavelength switching of the second light source is completed.

### Supplementary Note 6

The optical relay apparatus according to any one of supplementary notes 1 to 4, in which the first light source and the second light source are wavelength fixed light sources.

### Supplementary Note 7

The optical relay apparatus according to supplementary note 6, further including a plurality of light sources including the first light source and the second light source, in which
each wavelength of the plurality of light sources is related to a wavelength usable in an optical transmission system including the optical relay, and
the selection means selects any light of the plurality of light sources and outputs the selected light as the local oscillation light or the transmission light.

### Supplementary Note 8

The optical relay apparatus according to supplementary note 7,
in which the selection means includes:
a first selection means for selecting any light of the plurality of light sources and output the selected light as the local oscillation light, and
a second selection means for selecting any light of the plurality of light sources and output the selected light as the transmission light.

### Supplementary Note 9

The optical relay apparatus according to any one of supplementary notes 1 to 6, further including:
a third light source for outputting third light having a third wavelength; and
a fourth light source for outputting fourth light having a fourth wavelength,
in which the selection means includes:
   a first selection means for selecting either one of the first light and the second light and outputting the selected light as the local oscillation light; and
   a second selection means for selecting either one of the third light and the fourth light and output the selected light as the transmission light.

### Supplementary Note 10

The optical relay apparatus according to any one of supplementary notes 1 to 9, further including an automatic bias control means configured to control a bias voltage for coherent modulation of the coherent optical transmitter front-end means.

### Supplementary Note 11

The optical relay apparatus according to supplementary note 10, in which the automatic bias control means stops automatic bias control processing before switching the light selected by the selection means, and resumes the automatic bias control processing after switching the light selected by the selection means.

### Supplementary Note 12

The optical relay apparatus according to supplementary note 11, further including a storage means for storing the bias voltage before switching the light selected by the selection means, in which the automatic bias control means resumes the automatic bias control processing using the stored bias voltage after switching the light selected by the selection means.

### Supplementary Note 13

The optical relay apparatus according to any one of supplementary notes 1 to 12, further including a compensation means configured to compensate for distortion of a signal coherently detected by the coherent optical receiver front-end means,
in which the coherent optical transmitter front-end means coherently modulates the signal compensated by the compensation means.

### Supplementary Note 14

An optical transmission system including a plurality of optical relay apparatuses,
in which each of the plurality of optical relay apparatuses includes:
a coherent optical receiver front-end means for coherently detecting an input optical signal input from the optical relay apparatus of a preceding stage based on a local oscillation light;
a coherent optical transmitter front-end means for coherently modulating the coherently detected signal based on a transmission light and outputting the coherently modulated output optical signal to the optical relay apparatus of a subsequent stage;
a first light source for outputting first light having a first wavelength;
a second light source for outputting second light having a second wavelength; and
a selection means for selecting either one of the first light and the second light and outputting the selected light as the local oscillation light or the transmission light.

### Supplementary Note 15

An optical relay method including:
coherently detecting an input optical signal to be input based on a local oscillation light;
coherently modulating the coherently detected signal based on a transmission light and outputting the coherently modulated output optical signal; and
selecting either one of first light having a first wavelength output from a first light source and second light having a second wavelength output from a second light source, and outputting the selected light as the local oscillation light or the transmission light.

### REFERENCE SIGNS LIST

1 optical transmission system
2, 2-1 to 2-10, 9 optical relay apparatus
3 optical fiber transmission line
4,5 data center
6,7 IT service provider
8 event venue
21, 22 light source
100 wavelength conversion unit
110 coherent receiver front-end unit
111 polarization separation unit
112-1, 112-2 90° hybrid circuit
113-1 to 113-4O/E conversion unit
114-1 to 114-4 amplifier
120 coherent transmitter front-end unit
121-1 to 121-4 amplifier
122-1 to 122-4 MZ modulator
123 polarization multiplexing unit
130 selection unit
131 local oscillation light selection unit
132 transmission light selection unit
141 bias voltage storage unit
150 compensation unit
200 optical signal relay unit
210 control unit
220 wavelength selective switch
300 user interface unit
A1 to AN local oscillation light source
B1 to BN transmission light source
C1 integrated coherent receiver
C2 driver amplifier
C3 IQ modulator
CP1, CP2 optical coupler
SW1 to SW4 optical switch
VOA1 to VOA4 variable optical attenuator

What is claimed is:

1. An optical relay apparatus comprising:
a coherent optical receiver front-end unit coherently detecting an input optical signal to be input based on a local oscillation light;
a coherent optical transmitter front-end unit coherently modulating the coherently detected signal based on a transmission light and outputting the coherently modulated output optical signal;
a first light source for outputting first light having a first wavelength;
a second light source for outputting second light having a second wavelength; and
a selector selecting either one of the first light and the second light and outputting the selected light as the local oscillation light or the transmission light.

2. The optical relay apparatus according to claim 1, wherein the selector includes an optical switch configured to receive the first light and the second light and switch light to be output from the received light.

3. The optical relay apparatus according to claim 1,
wherein the selector includes:
a first variable attenuator for attenuating power of the first light with a set attenuation amount;
a second variable attenuator for attenuating power of the second light with a set attenuation amount; and
an optical coupler configured to multiplex the first light via the first variable attenuator and the second light via the second variable attenuator.

4. The optical relay apparatus according to claim 3, wherein either one of the first light and the second light is output from the optical coupler by controlling an attenuation amount of the first variable attenuator and an attenuation amount of the second variable attenuator.

5. The optical relay apparatus according to claim 1, wherein
the first light source and the second light source are wavelength variable light sources, and
in a case where light to be selected is switched from the first light to the second light, the selector switches the light to be selected to the second light after wavelength switching of the second light source is completed.

6. The optical relay apparatus according to claim 1, wherein the first light source and the second light source are wavelength fixed light sources.

7. The optical relay apparatus according to claim 6, further comprising a plurality of light sources including the first light source and the second light source, wherein
each wavelength of the plurality of light sources is related to a wavelength usable in an optical transmission system including the optical relay apparatus, and
the selector selects any light of the plurality of light sources and outputs the selected light as the local oscillation light or the transmission light.

8. The optical relay apparatus according to claim 7,
wherein the selector includes:
a first selector selecting any light of the plurality of light sources and output the selected light as the local oscillation light; and
a second selector means for selecting any light of the plurality of light sources and output the selected light as the transmission light.

9. The optical relay apparatus according to claim 1, further comprising:
a third light source for outputting third light having a third wavelength; and
a fourth light source for outputting fourth light having a fourth wavelength,
wherein the selector includes:
a first selector for selecting either one of the first light and the second light and outputting the selected light as the local oscillation light; and
a second selector selecting either one of the third light and the fourth light and outputting the selected light as the transmission light.

10. The optical relay apparatus according to claim 1, further comprising an automatic bias controller configured to control a bias voltage for coherent modulation of the coherent optical transmitter front-end means.

11. The optical relay apparatus according to claim 10, wherein the automatic bias controller stops automatic bias control processing before switching the light selected by the selector, and resumes the automatic bias control processing after switching the light selected by the selector.

12. The optical relay apparatus according to claim 11, further comprising a memory storing the bias voltage before switching the light selected by the selection means,
wherein the automatic bias controller resumes the automatic bias control processing using the stored bias voltage after switching the light selected by the selector.

13. The optical relay apparatus according to claim 1, further comprising a compensator configured to compensate for distortion of a signal coherently detected by the coherent optical receiver front-end unit,
wherein the coherent optical transmitter front-end unit coherently modulates the signal compensated by the compensator.

14. An optical transmission system comprising a plurality of optical relay apparatuses,
wherein each of the plurality of optical relay apparatuses includes:
a coherent optical receiver front-end unit coherently detecting an input optical signal input from the optical relay apparatus of a preceding stage based on a local oscillation light;
a coherent optical transmitter front-end unit coherently modulating the coherently detected signal based on a transmission light and outputting the coherently modulated output optical signal to the optical relay apparatus of a subsequent stage;
a first light source for outputting first light having a first wavelength;
a second light source for outputting second light having a second wavelength; and
a selector selecting either one of the first light and the second light and outputting the selected light as the local oscillation light or the transmission light.

15. An optical relay method comprising:
coherently detecting an input optical signal to be input based on a local oscillation light;
coherently modulating the coherently detected signal based on a transmission light and outputting the coherently modulated output optical signal; and
selecting either one of first light having a first wavelength output from a first light source and second light having a second wavelength output from a second light source, and outputting the selected light as the local oscillation light or the transmission light.
